(19) United States
(12) Patent Application Publication
(10) Pub. No.: US 2024/0271464 A1
(43) Pub. Date: Aug. 15, 2024

(54) MODULAR DOOR LOCK AND METHODS OF IMPLEMENTING A MODULAR DOOR LOCK

(71) Applicant: Smart Power Partners LLC, Wheaton, IL (US)

(72) Inventor: John J. King, Wheaton, IL (US)

(73) Assignee: Smart Power Partners LLC, Wheaton, IL (US)

(21) Appl. No.: 18/420,980

(22) Filed: Jan. 24, 2024

Related U.S. Application Data
(60) Provisional application No. 63/624,347, filed on Jan. 24, 2024.
(60) Provisional application No. 63/524,480, filed on Jun. 30, 2023.
(60) Provisional application No. 63/441,763, filed on Jan. 27, 2023.

(51) Int. Cl. E05B 63/00; E05B 47/00

(52) U.S. Cl. CPC E05B 63/0056; E05B 2047/0091

(57) ABSTRACT

A modular door lock adapted to be attached to a door is described. The modular door lock may comprise a bolt adapted to be received by a door frame; an interior lock portion comprising a first latch element adapted to control a movement of the bolt; and an exterior lock portion comprising a key actuator adapted to control a movement of the bolt; wherein the interior lock portion comprises a module that is removably coupled to the interior lock portion. A method of implementing a modular door lock is also disclosed.

### PRIORITY

Applicant claims priority to U.S. Application 63/441,763, filed Jan. 27, 2023, U.S. Application 63/524,480, filed Jun. 30, 2023, and U.S. Application 63/624,347, filed Jan. 24, 2024, the entire applications of which are incorporated herein by reference.

### TECHNICAL FIELD

Embodiments of the present invention relates generally to power adapters, devices, appliances and methods of implementing power adapters and control modules for monitoring conditions and controlling devices in a building.

### BACKGROUND

Power adapters, such as switches which control the application of power to a load (e.g., a light or other appliance) and outlets, are an important part of any residential or commercial building and can provide beneficial control of a load attached to the power adapter, such as timing control, motion detection, and dimming for example. As power adapters continue to advance, additional functionality may be available to a user of the power adapter. In addition to providing control, many power adapters may provide sensing capabilities. However, it may be difficult to integrate the various power adapters as a part of a single system. Further, homeowners may benefit from additional sensors or control capability associated with additional power adapter devices, or additional monitoring or functional control of devices other than the power adapters.

Accordingly, systems, circuits, devices, arrangements and methods that enable a user such as a homeowner or other building owner to easily and efficiently implement different power adapters are beneficial.

### SUMMARY

A modular door lock adapted to be attached to a door, the modular door lock comprising a bolt adapted to be received by a door frame; an interior lock portion comprising a first latch element adapted to control a movement of the bolt; and an exterior lock portion comprising a key actuator adapted to control a movement of the bolt; wherein the interior lock portion comprises a module that is removably coupled to the interior lock portion.

Another modular door lock adapted to be attached to a door may comprise a bolt adapted to be received by a door frame; an interior lock portion comprising a first latch element adapted to control a movement of the bolt; and an exterior lock portion comprising a key actuator adapted to control a movement of the bolt; wherein the exterior lock portion comprises a module that is removably coupled to the exterior lock portion.

A method of implementing a modular door lock adapted to be attached to a door is also disclosed. The method may comprise providing a bolt adapted to be received by a door frame; enabling controlling a movement of the bolt using a first latch element of an interior lock portion; and enabling controlling a movement of the bolt using a key actuator of an exterior lock portion; wherein one of the interior lock portion or the exterior lock portion comprises a module that is removably coupled to the modular door lock.

### BRIEF DESCRIPTION OF THE DRAWINGS

FIG. 1 is a block diagram of a system for monitoring and controlling a building.

FIG. 2 is a side view of a door lock attached to a door.

FIG. 3 is another side view of a door lock attached to a door.

FIG. 4 is a block diagram of a door lock attached to a door.

FIG. 5 is another block diagram of a door lock attached to a door.

FIG. 6 is another block diagram of a door lock of FIG. 5 attached to a door and showing a module detached from the door lock.

FIG. 7 is another block diagram of a door lock attached to a door.

FIG. 8 is another block diagram of a door lock of FIG. 7 attached to a door showing a module detached from the door lock.

FIG. 9 is another block diagram of a door lock attached to a door.

FIG. 10 is another block diagram of a door lock of FIG. 9 attached to a door showing a module detached from the door lock.

FIG. 11 is another block diagram of a door lock attached to a door.

FIG. 12 is another block diagram of a door lock of FIG. 11 attached to a door showing modules detached from the door lock.

FIG. 13 is a block diagram of a garage door opener adapted to receive a control module.

FIG. 14 is a block diagram of the garage door opener of FIG. 13 with the control module attached.

FIG. 15 is a block diagram of an indoor light adapted to receive a control module.

FIG. 16 is a block diagram of the indoor light of FIG. 15 with the control module attached.

FIG. 17 is a block diagram of an outdoor light adapted to receive a control module.

FIG. 18 is a block diagram of the outdoor light of FIG. 17 with the control module attached.

FIG. 19 is a block diagram of a smoke detector adapted to receive a control module.

FIG. 20 is a block diagram of the smoke detector of FIG. 19 with the control module attached.

FIG. 21 is a block diagram of a power adapter arrangement having contact elements configured to receive wires of a junction box.

FIG. 22 is a block diagram of a power adapter arrangements in a multi-way wiring arrangement.

FIG. 23 is a block diagram of a power adapter configured to be implemented as a companion switch power adapter in a multi-way wiring arrangement.

FIG. 24 is a flow chart showing a method of implementing a power adapter as a companion switch power adapter in a multi-way wiring arrangement.

FIG. 25 is a block diagram of a power adapter implemented as a primary switch power adapter in a multi-way wiring arrangement.

FIG. 26 is a flow chart showing a method of implementing a power adapter as a primary switch power adapter in a multi-way wiring arrangement.

FIG. 27 is a block diagram of a pair of power adapters configured in a multi-way wiring arrangement according to one implementation.

FIG. 28 is a flow chart showing a method of implementing a pair of power adapters according to the multi-way wiring arrangement of FIG. 27.

FIG. 29 is a block diagram of a pair of power adapters configured in a multi-way wiring arrangement according to another implementation.

FIG. 30 is a flow chart showing a method of implementing a pair of power adapters according to the multi-way wiring arrangement of FIG. 29.

FIG. 31 is a block diagram of a pair of power adapters configured in a multi-way wiring arrangement according to a further implementation.

FIG. 32 is a flow chart showing a method of implementing a pair of power adapters according to the multi-way wiring arrangement of FIG. 31.

FIG. 33 is a perspective view of a power adapter having an external indicator.

FIG. 34 is a perspective view of a power adapter having an internal indicator.

FIG. 35 is a block diagram of a power adapter configured to be implemented as a companion switch power adapter in a multi-way wiring arrangement and having an error detection circuit.

FIG. 36 is a block diagram of a power adapter configured to be implemented as a primary switch power adapter in a multi-way wiring arrangement and having an error detection circuit.

FIG. 37 is a block diagram of a high voltage detection circuit that may be implemented in the error detection circuit of FIG. 35 or 36.

FIG. 38 is a block diagram of a low voltage detection circuit that may be implemented in the error detection circuit of FIG. 35 or 36.

FIG. 39 is a block diagram of a power adapter arrangement configured to control multiple wirelessly controlled outlets using a common toggle signal according to one implementation.

FIG. 40 is a block diagram of a power adapter arrangement configured to control multiple wirelessly controlled outlets using a common on/off state signal according to one implementation.

FIG. 41 is a block diagram of a power adapter arrangement configured to control multiple wirelessly controlled outlets using signaling between wirelessly controlled outlet control modules according to one implementation.

FIG. 42 is a block diagram of a power adapter arrangement configured to control multiple wirelessly controlled outlets using multiple transmitters of a control module according to one implementation.

FIG. 43 is a user interface for a control module adapted to provide status information associated with a door, such as a garage door.

FIG. 44 is a user interface for a control module adapted to provide status information and a control interface associated with a door, such as a garage door.

FIG. 45 is a user interface for a control module adapted to provide status information associated with multiple doors, such as garage doors.

FIG. 46 is a user interface for a control module adapted to provide status information and a control interface associated with multiple doors, such as garage doors.

FIG. 47 is an example of a user interface of a door chime control module associated with a doorbell camera.

FIG. 48 is a user interface of a control module enabling determining status and providing control of an associated doorbell camera.

FIG. 49 is a user interface of a control module enabling controlling settings of an associated doorbell camera.

FIG. 50 is an example of a control module having a dedicated display.

FIG. 51 is a system for integrating control modules associated with different control functions associated with a building such as a residential building.

### DETAILED DESCRIPTION

Conventional systems of home monitoring and control of various devices such as lighting devices or appliances in the home are limited. It is also difficult to integrate a variety of different devices controlling or monitoring other devices or appliances. The circuits, devices, systems and methods for monitoring conditions and controlling devices, such as switches and outlets or devices or appliances controlled by switches and outlets, of a building provide a benefit to homeowners and owners of buildings.

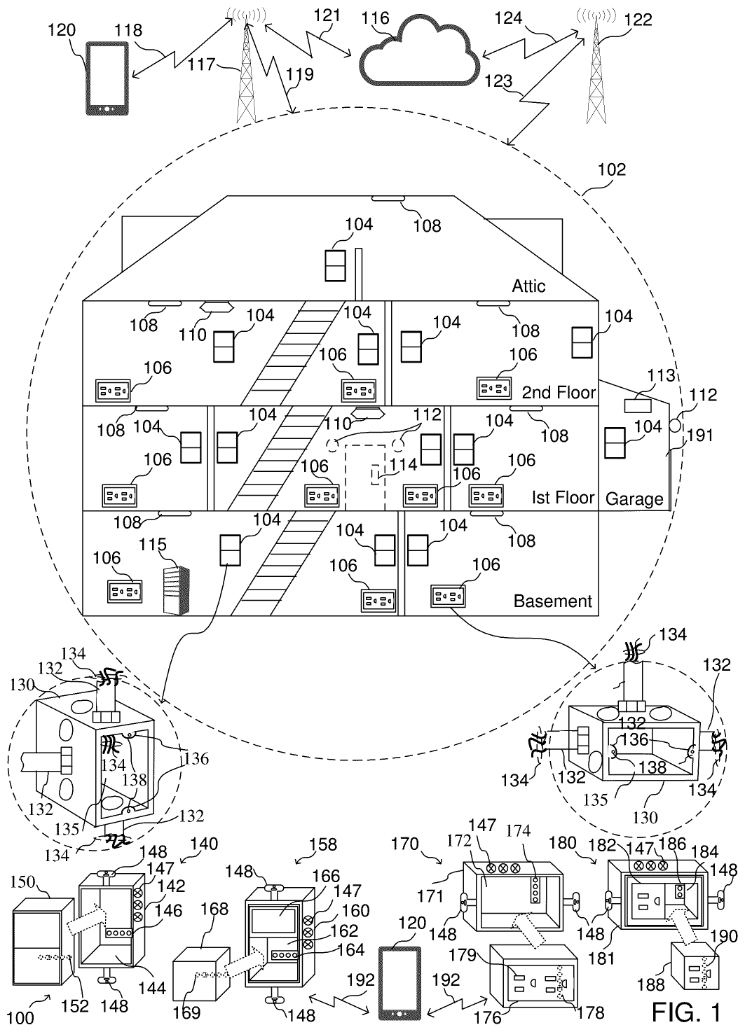

Turning first to FIG. 1, a block diagram of a system 100 for monitoring and controlling a building is shown. The system 100 comprises a building 102, which may be a residential building, a commercial building, a portion of a residential or commercial building, or some other structure having power adapters that control devices and appliances. The building 102 comprises a plurality of levels, shown here by way of example as a basement, a first floor, a second floor, and an attic. A garage, which is included by way of example as being attached to the first floor, is also shown.

Each of the levels comprises various devices that may be controlled according to the system set forth in more detail below. The building 102 may comprise a variety of power adapters, including power adapters 104 that function as switches for controlling the application of power to a load, such as a light or appliance controlled by the switch, or outlets 106, also commonly called receptacles, shown by way of example here as comprising duplex outlets. As will be described in more detail below, the power adapters may comprise integrated power adapters which are not modular but include all the elements of the power adapter in a single device, or power adapter arrangements comprising a power adapter and a control module. As will be described in more detail below, the control module may comprise part or all of the functionality of the power adapter.

The building may also comprise various detector devices 108, such as a smoke detector, a carbon monoxide detector, or some other type of air quality detector, which may be standalone devices or connected to a power adapter in a junction box. Described in more detail below, the detector devices may be adapted to receive a control module according to other implementations.

The building may also comprise various light fixtures, including both indoor light fixtures 110 and outdoor light fixtures 112. A garage may also include a garage door opener 113. As will be described in more detail below, the light fixtures may also be adapted to receive a control module.

A door lock 114 associated with the door, shown in dashed lines, may also be included. The door lock 114 may comprise a modular door lock and have various interfaces, both on the inside of the door and the outside of the door, enabling a user to receive or provide Information as will be described in more detail below.

The various devices of the building 102 may be adapted to communicate, wirelessly or by way of a wired communication link, with elements within the building, or outside the building, shown here by way of example as one or more communication links with a remote computer network 116, often referred to as the cloud which may include one or more servers for storage or processing capability. A communication device 115 is shown by way of example within the house. While the communication device is shown separate from the power adapters and other devices, the communication device 115 could be integrated into one of the power adapters or devices. By way of example, the communication device 115 could be a computer or a computer server having wired or wireless communication capability, a router (such as a WiFi router) in communication with a computer or server, or a communication network hub (such as a Z-Wave or Zigbee hub) in communication with a computer or server. The communication device 115, or communication capability of any of the other power adapters or devices in the building 102, enables communication with one or more external devices or networks. The communication device could be any type of communication device, including a fixed or mobile communication device that is adapted to communicate using any communication protocol. The communication device may be adapted to enable communication between all of the devices of the building 102 and with other devices or communication networks external to the building. By way of example, the communication device 115 may communicate with the remote computer network 116 by way of a communication network 117 that may communicate with the remote computer network 116 by way of a communication link 118 and with a mobile communication device 120 or some other device of the building 102 by way of a communication link 119 or by way of some other communication link such as a local area communication link (e.g., WiFi) or a short range communication link such as Bluetooth or near field communication (NFC).

As will be described in more detail below, a mobile communication device 120, inside the building 102 or external to the building 102, may communicate with different devices within the building 102 or external to the building 102. For example, a mobile communication device 120 at a remote location may communicate with the communication network 117 by way of a communication link 118 and with devices such as the communication device 115 or another mobile communication device 120 in the building 102 by way of the communication link 119, or with the remote computer network 116 by way of the communication link 121. A mobile communication device 120 within the building may also communicate with a second communication network 122 by way a communication link 123 and to the remote computer network 116 by way or a communication link 124. Mobile communication devices 120 within and outside of the building may communicate with each other by way of the various communication networks. The communication networks 117 and 122 could comprise cellular communication networks, conventional landline networks or a combination of a cellular and landline network for example, or any other type of wired or wireless communication network.

The building also receive power, commonly known as line power, that is distributed to various power adapters that may be installed in junction boxes which are commonly implemented in buildings. More particularly, junction boxes 130 may be coupled to conduit 132 having wires 134 that may be used to provide power or other reference voltages (e.g., line or neutral) or signals to power adapters by way of terminal portions of the wires 134 that extend into a recess 135 adapted to receive a power adapter. Flanges 136 are adapted receive a screw or other attachment element, such as by way of a threaded portion 138 to enable attaching corresponding flanges of the power adapter to the flanges 136. Junction boxes 130 are commonly installed in residential and commercial buildings, and may be attached to a stud behind wall board material for example. Power adapters installed in a junction box may be considered an in-wall power adapter.

In addition to power adapters that comprise single piece units, such as switches or outlets that are not adapted to receive control modules and all interface and control elements of the power adapter are integrated in the power adapter, various power adapter arrangements having a power adapter and a control module may be used. More particularly, a power adapter arrangement 140 comprises a power adapter 142 having a recess 144 that comprises a plurality of contact elements 146. The power adapter also comprises flanges 148 that are adapted to be coupled to corresponding flanges 136 of a junction box. The control module 150 comprises contact elements 152 (shown in dashed lines as being at the back of the control module) that are adapted to be electrically coupled to the contact elements 146 of the power adapter, where the combination of the power adapter and the control module form the power adapter arrangement. The power adapter 142 also comprises contact elements external to the power adapter, such as wires extending from the power adapter or screw terminals and accessible on one or more outer surfaces of the power adapter, shown by way of example as screw terminals 147, that are adapted to be connected to the wires 134 of the junction box, and may be used to control a load, such as a light fixture or other appliance. For example, the control module 150 may comprise a rocker switch as shown for controlling the state of a light for example. According to the power adapter arrangement 140, the control module 150 provides the user interface elements of the power adapter arrangement.

A power adapter arrangement 158 is also shown. The power adapter arrangement 158 comprises a power adapter 160 having a recess 162 that comprises a plurality of contact elements of an electrical interface 164. The power adapter also comprises a switch actuator 166, shown here by way of example as a push button switch, but could be any type of switch, such as a toggle switch or a rocker switch. A control module 168 comprises a plurality of contact elements 169 that are adapted to be electrically coupled to the plurality of contact elements of an electrical interface 164. The control module can be adapted to control the application of power to a load for example. That is, in addition to the functionality of the switch actuator 166, the control module 168 may comprise a wireless communication circuit adapted to receive wireless communication signals for controlling the state of the power applied to the load by the power adapter arrangement. The control modules may comprise circuits and interfaces for controlling that application of power to a load, and may enable motion sensing, dimming, timing, or other functionality.

A wireless communication circuit in any of the power adapters, control module or other devices of the system 100 could implement one or more of any type of wireless communication protocol, such as WiFi, Z-wave, Zigbee, Matter, Thread, Bluetooth, near field communication (NFC), any variation of those protocols, or any type of proprietary wireless communication protocol for example.

A power adapter arrangement 170 is also shown. The power adapter arrangement 170 comprises a power adapter 171 having a recess 172 that comprises a plurality of contact elements 174. A module 176 comprises a plurality of contact elements 178 adapted to be electrically coupled to the plurality of contact elements 174. The module comprises a pair of outlets 179, commonly known as a duplex receptacle and shown by way of example as having outlets adapted to receive a 3-prong plug for providing neutral, ground, and line power signals to a device plugged into the outlet.

A power adapter arrangement 180 is also shown. The power adapter arrangement 180 comprises a power adapter 181 having an outlet 182 and a recess 184 comprising a plurality of contact elements 186. A module 188 comprises a plurality of contact elements 190 adapted to be electrically coupled to the plurality of contact elements 186. Additional details related to the various power adapter arrangements will be described in more detail below. The mobile communication device 120 may communicate with one or more of the power adapter arrangements by way of a wireless communication link 192. The wireless communication link 192 could be a short range communication link, such as a Bluetooth communication link or a NFC communication link, or by way of a local area network such as a Wi-Fi, Z-Wave or Zigbee network, or by way of a wide area network, such as a cellular communication network, or a combination of the these various types of networks.

According to various implementations, control modules may be used in a power adapter to provide information based upon a sensor reading of a sensor of the control module. For example, the control modules may comprise sensors associated with lighting controls, such as a light sensor for enabling the auto dimming or the changing of states of the lights or other sensors for detecting other atmospheric conditions.

According to other implementations, control modules may comprise sensors associated with a status of a device or location of the device in the building, such as a sensor 191 associated with a garage door for indicating an open/closed status of the garage door, a sensor associated with vehicle detection, which may indicate when a vehicle is in the driveway or the garage or is entering the driveway or garage, as sensor associated with air quality, including particularly related to a garage application. Sensors may also be associated with outdoor conditions, such as a sensor associated with a gutter, and a condition associated with a water overflow condition of the gutter. A control module may also include a sensor for water detection associated with a basement, such as near a water heater or sump pump, or near kitchen appliances, such as a kitchen sink or a dishwasher. The control module may include a tether to the sensor for convenient placement of the sensor near the source of water. Various sensors included in a control module for a power adapter, a door lock, an indoor or outdoor light, a smoke detector or any other element of the system of FIG. 1 may comprise a temperature sensor, a humidity sensor, a motion sensor, a vibration sensor, a glass break sensor, an air quality sensor, an ambient light sensor, or any other sensor adapted to detect a physical or an environmental condition.

According to other implementations, control modules may be adapted to control certain devices, or provide advanced control. For example, a control module may provide control of a damper associated with a vent covering an air duct. A control module may control a heated driveway, or a heated floor in a bathroom. A control module may enable operational control of a device in a building, such as a garage door opener. According to other embodiments, a control module having a sensor detecting when a garage door is opened or closed or whether a vehicle is in a garage or driveway may communicate with another control module to indicate a change in the state of a garage door or vehicle, such as by an audible or visual indicator of the other control module.

Control modules may be implemented to enhance home security. According to some implementations, a control module may interact with a door lock, such as a modular door lock as described below, and exchange information between the control module, the door lock and a doorbell. While power adapters provide many opportunities to provide information to a homeowner, a door lock, such as a door lock extending to the outside, enables a user of the door lock or a visitor to the home to provide or receive information, including for example when a user is inside the home or outside the home. The door lock may be a part of the system and interact with any of the power adapters or other devices of the home. Various aspects of door locks having additional functionality, including modular door locks, are described in more detail below.

Cameras may also be integrated in control modules and in the door lock and doorbell. Control modules may also detect sounds, including for example the sound of glass breaking. Control modules may also detect the open or closed state of a window, or other information, such as the presence of people or animals. Control modules may be implemented to enable power monitoring or the state of appliances, such as appliances commonly used in a kitchen or a laundry room for example. According to other implementations, control modules may be integrated as a part of heating, ventilation and air conditioning (HVAC) systems. While a plurality of contact elements of a power adapter or other device or appliance adapted to receive a control module or other type of module is described in the various implementations below, it should be understood that a plurality of contact elements merely provides one type of electrical interface between a power adapter or other device or appliance adapted to receive a control module or other type of module, other types of electrical and communication interfaces such as an optical electrical interface or an inductive electrical interface could be used for example. That is, while pairs of pluralities of contact elements having contacts that are electrically connected are provided by way of example, other types of electrical interfaces could be implemented.

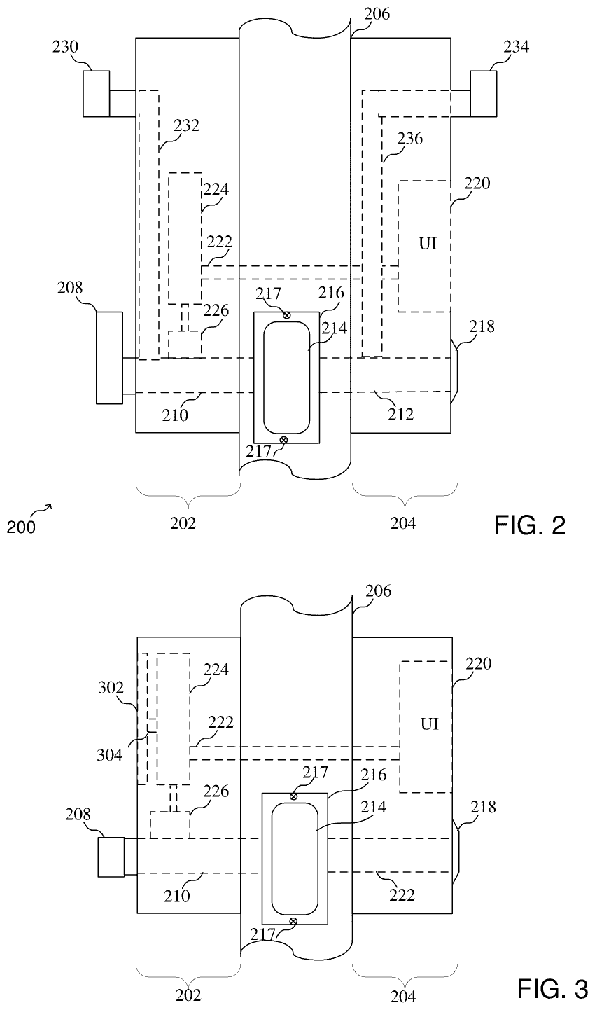

Turning now to FIG. 2, a side view of a door lock attached to a door is shown. A door lock 200 comprises an interior lock portion 202 and an exterior lock portion 204, shown here attached together on either sides of a door 206 and control a door bolt integrated in an opening of the door as will be described in more detail below. A turn element 208 associated with the interior lock portion 202 enables a user to lock or unlock the door. According to some implementations, the turn element 208 could be a key. A latch element 210 extends to a corresponding latch element 212 on the opposite side of the door and is adapted to move a bolt 214, which comprises a retractable bolt (also referred to as a dead bolt) that is adapted to be received a door frame (such as by a strike plate) to which the door is attached and may be associated with what is commonly known as a dead bolt system, through a strike 216 which is attached to the door using screws 217. The latch element 210 and 212 may comprise a single piece, and may comprise gears that mate with corresponding gears of the bolt 214 to cause the bolt to move into a recess of the door frame to prevent the door from being opened. The latch elements 210 and 212 may often be called a rotor, spindle or torque blade depending upon the implementation and enables the movement of the bolt into or out of a strike plate of the door frame. While the turn element 208 enables locking or unlocking the door by way of the latch element 210, a key inserted into the key actuator 218 enables the latch element 212 to lock or unlock the door from the outside.

A user interface 220, which may comprise a modular user interface as will be described in more detail below, Is coupled by a communication interface 222, which may be a cable having or a plurality of wires or may be an optical communication link, to a control circuit 224. The control circuit 224 controls the operation of a rotator element 226 to enable moving the bolt 214 between a locked and an unlocked position, such as through the use of corresponding gears in the rotator element 226 and the latch element 210. Control signals may be sent from the user interface 220 to the control circuit 224 to enable unlocking the door. The user interface will be described in more detail below. The user interface 220 may comprise one or more of a keypad having physical keys, a touchscreen, a touchscreen device enabling an electronic keypad, a sensor, a camera, a display, a speaker, a microphone or any other type of input or output device or interface. The user interface 220 could comprise a combination of physical keys or actuators and a touchscreen device. The keypads could be a numeric keypad (i.e., 1-9, * and #) or an alphanumeric keypad for example. For a touchscreen enabling an electronic keypad, the touchscreen could have different modes enabling a numeric keypad or an alphanumeric keypad. The one or more sensors of the user interface 220 could comprise a biological detector (e.g., a fingerprint detector, a palm detector, a facial recognition detector, or an iris detector for example), a motion sensor, an infrared sensor, a heat sensor, or any type of sensor to detect the presence or absence of an object, person or animal in the vicinity of the door lock. The one or more sensors may also comprise may comprise a temperature sensor, a humidity sensor, a vibration sensor, a glass break sensor, an air quality sensor, an ambient light sensor, or any other sensor adapted to detect a physical or an environmental condition.

According to some implementation, handles may be included as part of a dead bolt system. More particularly, a first handle 230 associated with the interior lock portion 202, where the handle 230 is coupled to a door bolt control element 232 for controlling the latch element 210 to move the bolt 214. The latch control element 232 may also comprise gears that engage with corresponding gears of the latch element 210 to control the movement of the bolt 214. A second handle 234 associated with the exterior lock portion 202, where the handle 234 is coupled to a door bolt control element 236 for controlling the latch element 212 to move the bolt 214. The latch control element 232 may also comprise gears that engage with corresponding gears of the latch element 210 to control the movement of the bolt 214. The implementation of the handles 230 and 234 are shown by way of example, it should be understood that the handles could be implemented using a different mechanical arrangement, including using a separate bolt (also often referred to as a latch). While the handles 230 and 234 are only shown in FIG. 2 and the implementations of FIGS. 3-12 do not include handles, it should be understood that the implementations of FIGS. 3-12 could also include handles 230 and 234, or some similar handles. It should also be understood that the handles could provided as a separate element with a separate bolt for the implementations of FIGS. 3-12.

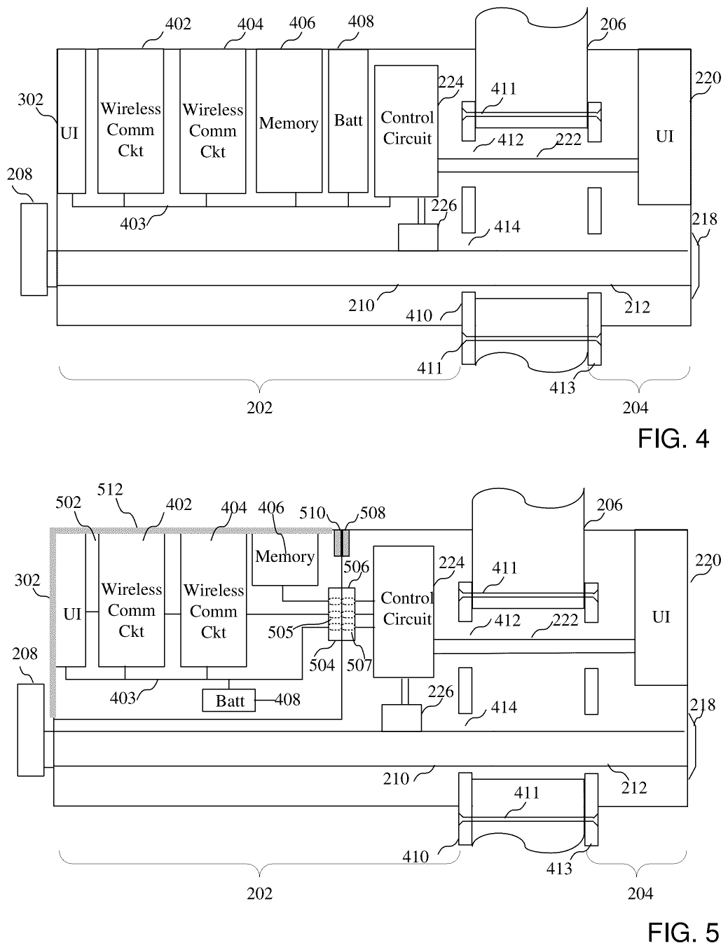

Turning now to FIG. 3, another side view of a door lock attached to a door is shown. According to the implementation of FIG. 3, a user interface 302 is coupled by a communication interface 304 to the control circuit 224. The communication interface 304, which may be a cable having or a plurality of wires or which may be an optical communication link, to a control circuit 224. Additional aspects of the user interface 302 will be provided in more detail below. The various elements of the interior lock portion and exterior lock portion of FIGS. 2 and 3 are shown in dashed lines as being within the interior lock portion and the exterior lock portion and will be shown in more detail in the block diagrams of FIGS. 4-12.

The user interface 302 may also comprise one or more of a keypad having physical keys, a touchscreen, a touchscreen enabling an electronic keypad, a sensor, a camera, a display, a speaker, a microphone or any other type of input or output device or interface. The sensor may comprise a temperature sensor, a humidity sensor, a motion sensor, a vibration sensor, a glass break sensor, an air quality sensor, an ambient light sensor, or any other sensor adapted to detect a physical or an environmental condition. The keypads could be a numeric keypad (i.e., 1-9, * and #) or an alphanumeric keypad. For a touchscreen enabling an electronic keypad, the touchscreen could have different modes enabling a numeric keypad or an alphanumeric keypad. The one or more sensors could comprise a biological detector (e.g., a fingerprint detector, a palm detector, a facial recognition detector, or an iris detector for example), a motion sensor, an infrared sensor, a heat sensor, or any type of sensor to detect the presence or absence of an object, person or animal in the vicinity of the door lock. The sensor may comprise a temperature sensor, a humidity sensor, a vibration sensor, a glass break sensor, an air quality sensor, an ambient light sensor, or any other sensor adapted to detect a physical or an environmental condition. The user interface 302 may interact with the user interface 220. For example, the user interface 302 may enable someone on the inside of the door to see, hear, and speak to someone on the outside of the door. Similarly, the user interface 220 may enable someone on the outside of the door to see, hear, and speak to someone on the inside of the door.

Turning now to FIG. 4, a block diagram of a door lock attached to a door is shown in cross-section. More particularly, the interior lock portion 202 may also comprise one or more wireless communication circuits, including for example a first wireless communication circuit 402 and a second wireless communication circuit 404. The interior lock portion may also comprise a memory 406 and a battery 408. Each of the wireless communication circuits 402 and 404 and the memory 406 and the battery 408 are coupled to the control circuit 224 by way of a bus 403 that enables sending and receiving signals, including a power signal. A plate 410, which may be a part of a housing of the interior lock portion which enables attaching the interior lock portion to the door, comprises a first opening 412 that enables the communication interface 222 to extend between the user interface 220 and the control circuit 224, and a second opening 414 that enables latch elements 210 and 212, shown here by way of example as a single latch element, to extend between the turn element 208 and the key actuator 218. A plate 413, which may be a part of a housing portion of the exterior lock portion and have similar openings as the plate 410, may be used to enable attaching the exterior lock portion to the interior lock portion by way of one or more bolts 411 that extend between the plates 410 and 413. According to some implementations, it may be possible to replace one or more of the wireless communication circuits, the memory or the battery for example, as will be described in more detail below.

Turning now to FIG. 5, another block diagram of a door lock attached to a door having a detachable module is shown in cross-section. According to the implementation of FIG. 5, a module 502 comprising the user interface 302, the wireless communication circuit 402, the wireless communication circuit 404, the memory 406, and the battery 408 can be attached and detached from the interior lock portion 202. According to some implementations, the module 502 may be attached to the interior lock portion by way of a pair of connectors 504 and 506, each having a plurality of contact elements 505 and 507 that are electrically connected as shown in FIG. 5 and in other connectors in other figures. The module 502 may also comprise attachment elements 508 and 510 adapted to attach the module 502 to other elements of the interior lock portion 202. The attachment elements 508 and 510 could be for example corresponding latch elements for securing the module 502 to the interior lock portion 202. However, it should be understood that the attachment elements could be any type of elements that are adapted to attach the module 502 to the interior lock portion 202, such as flange elements that are configured to mate with one another, magnetic elements, a screw and corresponding threaded portion, or any other method of attaching the module 502 to the remaining portion of the interior lock portion 202.

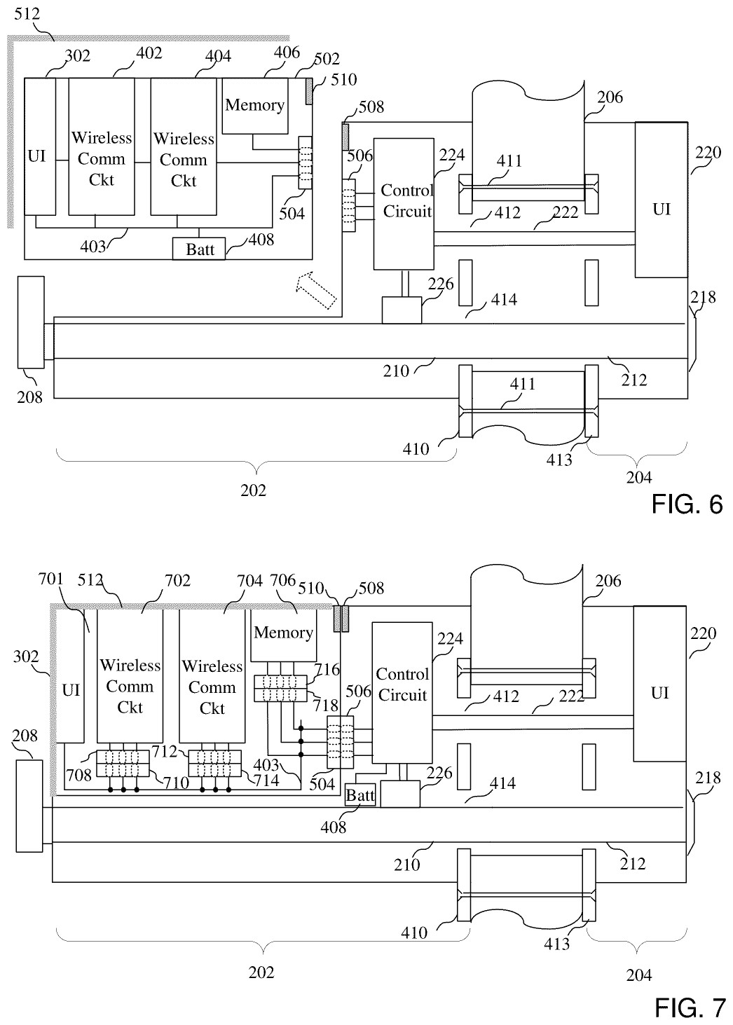

The connectors 504 and 506 and the attachment elements 508 and 510 enable the module 502 to be detached by a user of the lock (e.g., a homeowner) from the interior lock portion 202 as shown in FIG. 6. The module 502 can be replaced with a module having different features. For example, a different module may have one or more different wireless communication circuits or different memory capacity. According to some implementations, the module 502 can be removed without the use of tools such as a screwdriver. According to some implementations, the module 502 may be placed behind a cover 512 and can be removed after the cover or housing is removed. Such an arrangement would enable modules to be implemented in a variety of different door locks that have a different appearance. That is, the cover 512 over the module may have a different appearance for different door locks, where each cover or housing is adapted to cover each different type of module. The cover 512 could slide on and off, or could be removably attached using attachment elements. As will be described in more detail in reference to FIG. 7 below, it may also be possible to replace one or more of one the wireless communication circuit 402, the wireless communication circuit 404, or the memory 406.

Turning now to FIG. 7, another block diagram of a door lock attached to a door and having a detachable module is shown. According to the implementation of FIG. 7, the module 701 may comprise one or more detachable modules. That is, one or more of a wireless communication circuit 702, a wireless communication circuit 704, or a memory 706, could be removed and replaced with a different module having similar functionality (e.g., a wireless communication circuit being replaced with a different type of wireless communication circuit) or a different module having different functionality (e.g., a wireless communication circuit being replaced with a battery). For example, the wireless communications circuit 702 could be coupled to the bus 403 by way of a pair of connectors 708 and 710, the wireless communication circuit 704 could be coupled to the bus 403 by way of a pair of connectors 712 and 714, and the memory could be connected to the bus 403 by way of a pair of connectors 716 and 718. It should be understood that the battery 408 could be connected to the control circuit 224 using a connector and could be replaced. It should also be understood that the wireless communication circuits 702 and 704 and the memory 706 could be implemented as modules and swapped out according to an implementation of a door lock that does not have a removable module 701, such as the implementation of FIG. 4. That is, while the module 701 would not be removable, various elements of the module, such as the wireless communication circuits 702 and 704 and the memory 706, could be removable. It should also be understood that door lock may be provided by a manufacturer without the module 701 or without one or more of the wireless communication circuits 702 and 704 and the memory 706.

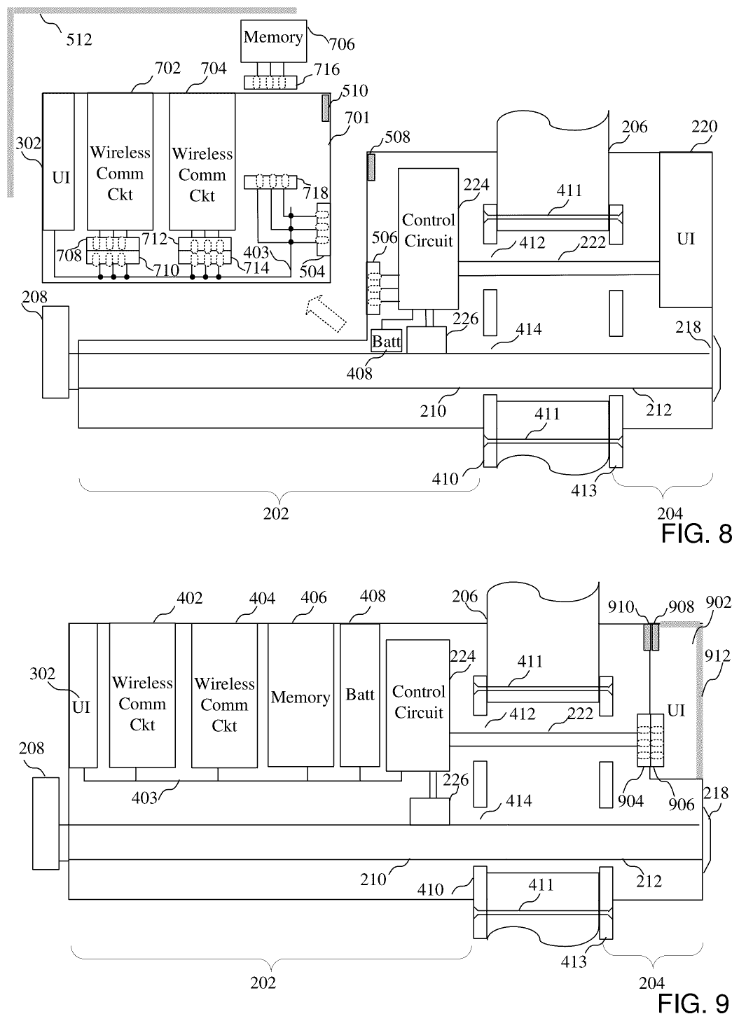

As shown in FIG. 8, both the module 701 is shown detached from the interior lock portion 202, and the memory 706 is shown detached from the module 701. It should be understood that the wireless communication circuits 702 and 704 could also be detached and replaced with a different wireless communication circuit module in a similar manner. It should also be understood that a battery could be a part of the module 701, in addition to or in place of the battery 408 according to some implementations, where one or both of the batteries could be detached and replaced. While the detachable modules are shown as a part of a module 701, it should be understood that the removable functional modules could be implemented with the interior lock portion a module 701 that is detachable according to another implementation. That is, the wireless communication circuits 702 and 704 and the memory 706 could be removed after the cover 512 is removed, but the module 701 could not be removed.

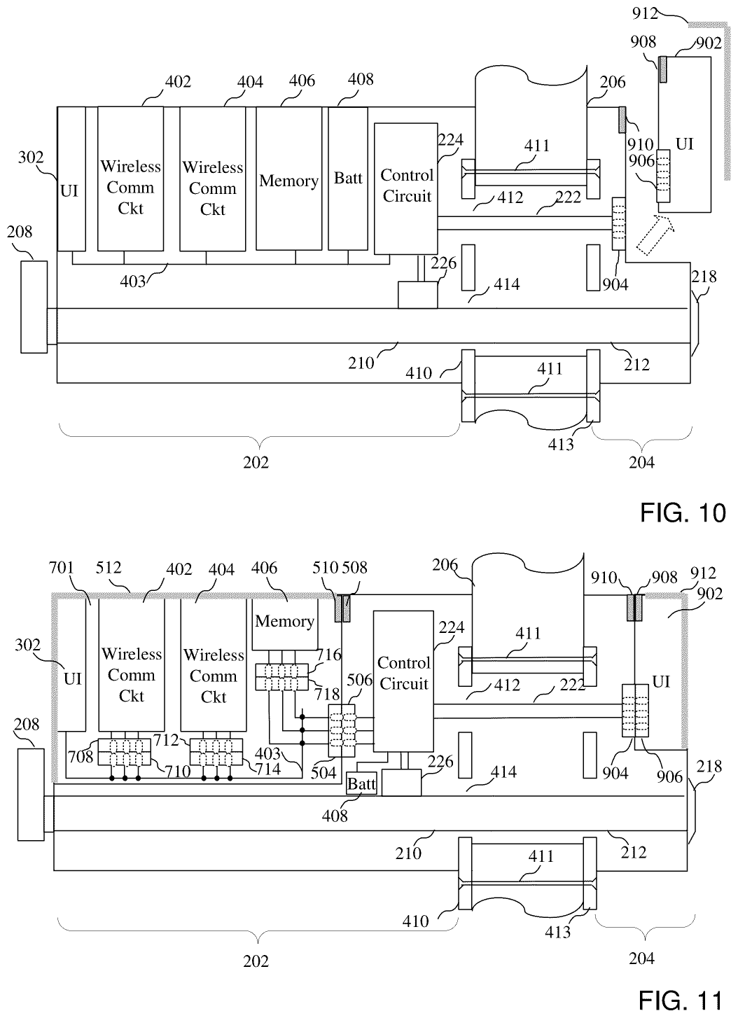

Turning now to FIG. 9, another block diagram of a door lock attached to a door and having a detachable module associated with the exterior lock portion 204 is shown. According to the implementation of FIG. 9, the removable module 902, which may comprise one or more of a user interface (UI), a wireless communication circuit, a memory, or a battery for example, may be attached and reattached to the exterior lock portion, such as by way of a pair of connectors 904 and 906. The module 902 may also comprise attachment elements 908 and 910 adapted to attach the module 902 to the remaining part of the exterior lock portion 204. The attachment elements 908 and 910 could be for example corresponding latch elements for securing the module 902 to the exterior lock portion 204. The attachment elements could be any type of elements that are adapted to attach the module 902 to the exterior lock portion 204, such as flange elements that are configured to mate with one another, magnetic elements, a screw and corresponding threaded portion, or any other method of attaching the module 902 to the exterior lock portion 204. According to some implementations, the module 902 may be placed behind a cover 912 and can be removed after the cover or housing is removed. Such an arrangement would enable modules to be implemented in a variety of different door locks that have a different appearance. That is, the cover 912 over the module may have a different appearance for different door locks, where each cover or housing is adapted to cover each different type of module. The cover 912 could slide on and off, or could be removably attached using attachment elements. As shown in FIG. 10, the module 902 on the exterior lock portion 204 is shown detached, and could be replaced with a different user interface. The cover 912 is also shown detached and the module 902 could be replaced with a different module. It should be understood that in some implementations the module 902 may also comprise individual modules that may be detached and replaced as described in reference to FIGS. 7 and 8, where the module 902 may be a fixed module or a removable module.

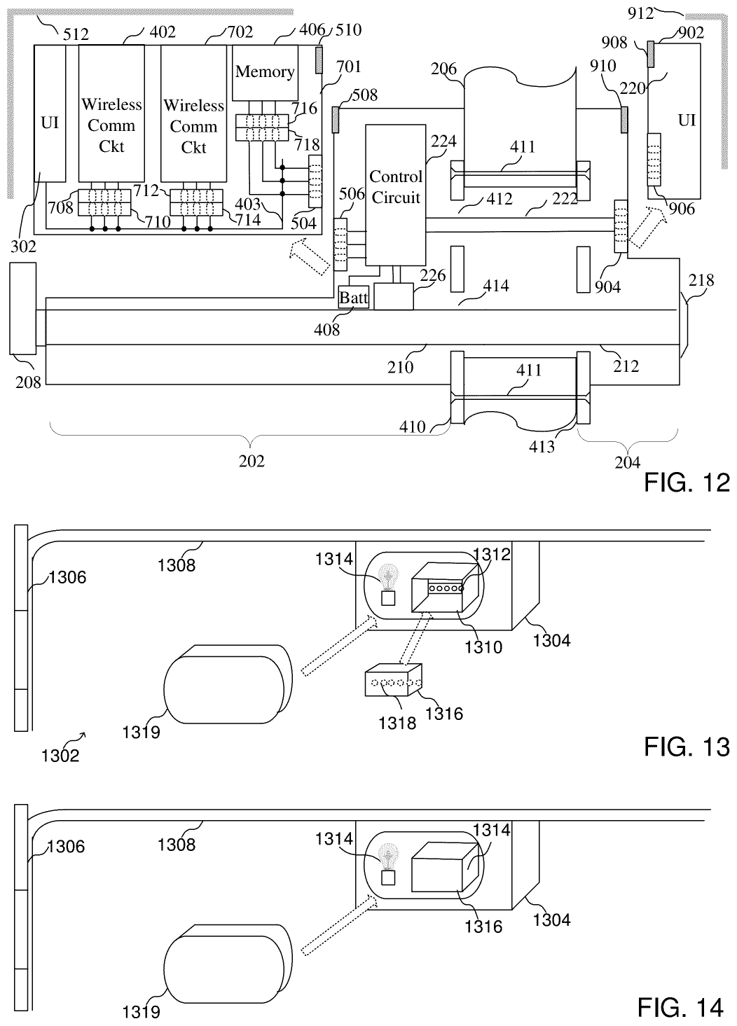

Turning now to FIG. 11, another block diagram of a door lock attached to a door and having detachable modules associated with both the interior door lock portion and the exterior door lock portion is shown. According to the implementation of FIG. 11, the interior lock portion comprises the removable module 701, as described above in reference to FIG. 7, and the exterior lock portion comprises the removable module 902, as described above in reference to FIG. 9. As shown in FIG. 12, both the module 701 and the module 902 are shown detached from the door lock.

In addition to the use of control modules with power adapters as described above in reference to FIG. 1, various appliances could also receive control modules as will be described in reference to FIGS. 13-20. Turning first to FIG. 13, a block diagram of a garage door opener adapted to receive a control module is shown. More particularly, a garage door opener arrangement 1302 comprises a garage door opener 1304 adapted to move a garage door 1306 along rails 1308, as is commonly performed. The garage door opener 1304 comprises a receiving element 1310 having a plurality of contact elements 1312. The receiving element 1310 is adapted to receive a control module 1316 having a plurality of contact elements 1318. The control module 1316 may perform a variety of functions, including providing a wireless communication signal to a user of the garage door opener indicating the status of the garage door, or enable a user to open or close the garage door in response to an actuation of a conventional garage door opener placed on a wall of the garage or in response to a signal received from a control module adapted to be placed in a switch or outlet, as will be described in more detail below. The control module 1316 may also comprise one or more cameras showing various views of the garage. As shown in FIG. 14, a cover 1319 may be placed over a light bulb 1314 and the control module 1316.

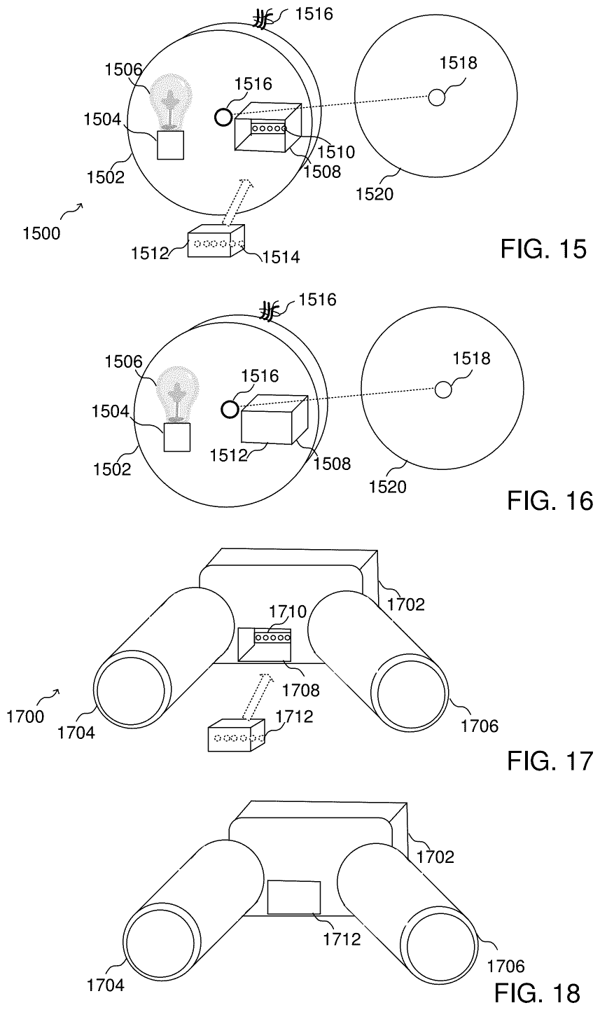

Turning now to FIG. 15, a block diagram of an indoor light fixture 1500 adapted to receive a control module is shown. As shown in FIG. 15, the indoor light fixture 1500 comprises a base 1502 having a receptacle 1504 for receiving a light bulb 1506. The light fixture also comprises a receiving element 1508 having a plurality of contact elements 1510, and a control module 1512 having a plurality of contact elements 1514 adapted to be coupled to the plurality of contact elements 1510. An attachment element 1516, such as a threaded screw portion, is adapted to receive an opening 1518 of a cover 1520 for the light. As shown in FIG. 16, the control module 1512 is received by the receiving element 1508 of the light fixture.

Turning now to FIG. 17, a block diagram of an outdoor light fixture 1700 adapted to receive a control module is shown. More particularly, the outdoor light fixture 1700 comprises a base 1702 having two lighting elements 1704 and 1706 extending from the base. The lighting elements may be movable to be shined in certain locations, as is commonly done. While two lighting elements are shown by way of example, it should be understood that any number of lighting elements could be implemented. The base 1702 also comprises a receiving element 1708 having a plurality of contact elements 1710. As shown in FIG. 18, the control module 1712 is attached to the base 1702. According to some implementations, a cover could be implemented and used to cover the control module.

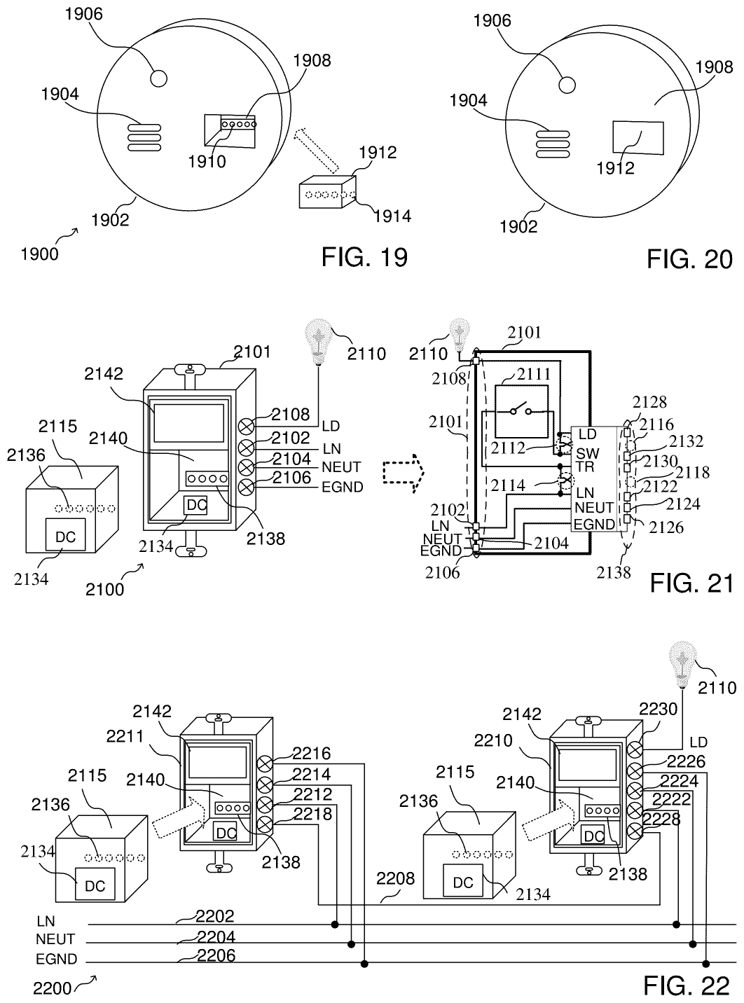

Turning now to FIG. 19, a block diagram of a smoke detector 1900 adapted to receive a control module is shown. The smoke detector comprises a base portion 1902 having a vent 1904 for receiving air flow and may comprise a light 1906, which may be an LED for example, for providing a status indication or for some other function. The base may also comprise a receiving element 1908 having a plurality of contact elements 1910. The receiving element 1908 is adapted to receive a control module 1912 having a plurality of contact elements 1914 adaptive to be coupled to the contact elements 1910. FIG. 20 shows a block diagram of the smoke detector of FIG. 19 with the control module 1912 attached. While some examples of appliances adapted to receive control modules are shown, it should be understood that other types of appliances adapted to receive control modules could be used.

According to some implementations, the receiving element may provide some or all of the same reference voltages (e.g., line, neutral and ground) as used with the power adapters of FIG. 1 to enable control modules used for the power adapters to be used in the various devices of FIGS. 13-20. For example, a control module having a timer or dimmer functionality could be used in one of the indoor outdoor lights so that the same modules could be used throughout the entire building. Providing an AC power signal to the module eliminates the need to include a transformer in a device, such as a light fixture that would not have any other need for a circuit that generates a DC power signal, and the transformer would be provided in the control module, and therefore only provided when a control module is used and not in a light fixture where a control module may never be used (i.e., a transformer would never be needed. Such an arrangement reduces the cost of the overall system because it prevents providing a printed circuit board and transformer in a device such as a light fixture that may never receive a control module. According to other implementations, DC voltages could be provided by the appliance to the control module. That is, in some cases, such as for the garage door opener, a printed circuit board of the garage door opener may already have a transformer that generates a DC power signal. According to still other implementations, the device could be adapted to provide both AC signals and DC power signals, where the module would use the appropriate power signal based upon the type of module.

As described above in reference to the system 100, different types of power adapters, including for example, a single pole power adapter or multi-way power adapters including primary and companion power adapters, may be implemented as will be described in more detail below. Because of the different functionality of the different switch power adapters (i.e., a single pole power adapter or multi-way power adapters), and particularly a possible combination of a switch power adapter and a module that each may be adapted to control the application of power to a load through a power switch (e.g., a relay or TRIAC for example), it may be beneficial for a module to be able to detect the type of switch power adapter in which it is installed to enable a power switch to remain in a state that does not draw any current when it is not being used to provide power to a load. FIGS. 21-38 describe various features of switch power adapters and switching modules that may improve the functionality and performance of the system. While reference may be made to a relay in various implementations described below, it should be understood that other types of power switches for routing line power to a load, such as a TRIAC or other power switching device, may be used in place of a relay in those implementations.

Turning now to FIG. 21, a block diagram of a power adapter arrangement 2100 having a power adapter 2101 comprising a plurality of contact elements adapted to receive wires of a junction box is shown. The power adapter 2101 having a switch is adapted to control a load in a single pole switch, also known as a one-way switching arrangement, where only one switch is adapted to control the load, shown here by way of example as a light bulb. The power adapter 2101 comprises a plurality of contact elements adapted to receive wires of a junction box. According to the implementation of FIG. 21, the plurality of contact elements comprises a first contact element 2102 adapted to receive a line voltage, a second contact element 2104 adapted to receive a neutral voltage, a third contact element 2106 adapted to receive a ground voltage, and a fourth contact element 2108 adapted to be coupled to a load 2110.

Additional elements of the power adapter 2101 are shown in circuit representation of the power adapter as shown on the right side of the dashed arrow in FIG. 21. More particularly, a switch 2111 is adapted to enable a user of the power adapter 2101 to switch the application of power provided to the load, such as in response to an actuation of an actuator 2142 by a user of the power adapter. Although actuator 2142 is shown as a push button actuator, it should be understood that actuator 2142 may be a rocker or toggle type actuator. The power adapter 2101 also comprises connectors 2112 and 2114 that enable connecting nodes of the power adapter, as will be described in more detail below. The connectors 2112 and 2114 enable control modules, such as a control module 2115 to change the operation of the power adapter based upon the type of power adapter used. The power adapter may also comprise openings 2116 and 2118 that receive actuators for controlling the connectors 2112 and 2114, as will be described in more detail below. The electrical interface 2138 comprises a plurality of contact elements, including a first contact element 2122 adapted to be coupled to a corresponding contact element of a control module to provide the line voltage from the power adapter 2101 to the control module, a second contact element 2124 adapted to be coupled to a corresponding contact element of a control module to provide the neutral voltage from the power adapter 2101 to the control module, a third contact element 2126 adapted to be coupled to a corresponding contact element of a control module to provide the ground voltage from the power adapter 2101 to the control module, a fourth contact element 2128 adapted to be coupled to a corresponding contact element of a control module, a fifth contact element 2130 adapted to be coupled to a corresponding contact element of a control module, and a sixth contact element 2132 adapted to be coupled to a corresponding contact element of a control module to receive the line voltage that is provided to the load by way of the power adapter. The fourth and fifth contact elements 2130 and 2132 enable the transfer of signals, which may be AC or DC signals through the switch 2111. The contact elements 2122-2128 are coupled to corresponding contact elements 2102-2108. The operation of the power adapter 2101 will be described in more detail below with respect to different control modules.

Turning now to FIG. 22, a block diagram of a power adapter arrangements in a multi-way wiring arrangement 2200 is shown. According to the implementation of FIG. 22, a plurality of power adapters are coupled to wires accessible in junction boxes, including a line wire 2202 having a line voltage, a neutral wire 2204 having a neutral voltage, and a ground wire 2206 having a ground voltage in a similar manner as wires of a junction box would be attached to the power adapter of FIG. 1. A power adapter 2210 implemented as a primary switch that controls the application of power to the load may be coupled to one or more power adapters 2211 implemented as a companion switch by a traveler wire 2208. While the power adapter 2210 may be implemented to control the load without the use of companion switches, the traveler wire enables the transfer of communication signals between the primary switch power adapter and the one or more companion switch power adapters.

The power adapter 2211 implemented as a companion switch comprises a plurality of contact elements adapted to be coupled to wires of a junction box, including a first contact element 2212 adapted to receive a line voltage, a second contact element 2214 adapted to receive a neutral voltage, a third contact element 2216 adapted to receive a ground voltage, and a forth contact element 2218 adapted to provide signals to the power adapter 2210 over the traveler wire 2208. The contact elements are coupled to corresponding wires accessible in a junction box as shown. Although a single power adapter 2211 implemented as a companion switch is shown, it should be understood that additional power adapters 2211 implemented as a companion switch could be wired in the same manner that power adapter 2211 is wired.

The power adapter 2210 implemented as a primary switch comprises a plurality of contact elements adapted to be coupled to wires of a junction box, including a first contact element 2222 adapted to receive a line voltage, a second contact element 2224 adapted to receive a neutral voltage, a third contact element 2226 adapted to receive a ground voltage, a fourth contact element 2228 adapted to be coupled to a traveler, and a fifth contact element 2230 adapted to be coupled to the load 2110 by a wire in a junction box. The contact elements 2222-2226 are also adapted to be coupled to corresponding wires accessible in a junction box as shown.

As will be described in more detail below, one or more of the switch power adapters or modules shown in FIGS. 21 and 22 may comprise a detection circuit (DC) 2134 enabling the module to detect the type of switch power adapter into which it is installed or enabling a switch power adapter to detect the type of module which it has received. The detection circuit 2134 of the control module 2115 of FIG. 21 comprises a plurality of contact elements 2136 adapted to be coupled to a plurality of contact elements of the electrical interface 2138 in a recess 2140 adapted to the receive the control module 2115. It should be understood that the detection circuit 2134 may provide different functionality depending upon the module or power adapter in which it is installed, as will be described in more detail below. When implemented in a switch power adapter, the detection circuit may be implemented using the processor of the switch power adapter. The power adapter arrangements of FIGS. 21 and 22 could be implemented in a building, such as a building shown in FIG. 1 or other similar environments.

Both the primary switch power adapter and any switching control module (i.e., a control module comprising a switch such as a relay or TRIAC for switching power to a load) may operate under certain conditions where the switch (e.g., a relay or TRIAC) of the primary switch power adapter (e.g., power adapter 2210) does not control the application of power to the load. Because current may be driven through a coil to hold the relay in a given state such as when turning on the relay, power may be consumed unnecessarily when a relay is turned on when no current is driven through it to drive a load. This condition may occur in at least two instances. A first instance may occur when a switching control module is used in a primary switch power adapter and performs the switching, in which case a switch (e.g., a relay or TRIAC) in the primary switch power adapter should remain open (i.e., does not switch power to the load and does not drive current). That is, the switching of power to the load is accomplished through and controlled by a switching element such as a relay or TRIAC of a switching control module. A second instance may occur when a switching control module is used in a companion switch power adapter, where the switching control module only needs to send a switching signal to the primary switch power adapter (e.g., over the traveler line or by way of a wireless communication signal where the switching of power to the load in performed in the primary switch power adapter), but does not need to switch its own relay and therefore can be held in an idle state to avoid unnecessarily turning on the relay when the control module is not driving current or not being used to control the application of power to a load.

In order to prevent unnecessary current draw in the first example, it may be necessary for the primary switch power adapter to detect or be informed that a switching control module is being used in the primary switch power adapter. In order to prevent unnecessary current draw in the second example above, it may be necessary for the switching control module to detect or be informed that it is in a companion switch power adapter.

According to some implementations, the ability to use a switching control module by itself in any type of switch power adapter may be accomplished by having a default operational mode for a switching control module, (e.g., the switching control module will switch its relay to control the application of power to a load as a default), where the operational mode of the switching control module may change based upon the detection of the type of switch power adapter that it is in (e.g., it will enter an operational mode of not switching the relay when the switching control module determines or is informed that it is in a companion switch, such as a signal only mode).

The following solutions not only reduce power consumption, but also enable the use of a switching control module in any of the three switch power adapter types: a single pole switch power adapter, a primary switch power adapter which performs the switching of power to a load in a multi-way switching arrangement, or a companion switch power adapter in a multi-way switching arrangement which provides control signals to the primary switch power adapter.

Considering first a primary switch power adapter, it is beneficial if the primary switch power adapter detects when it receives a switching control module, in which case the processor of the primary switch power adapter may maintain its power switch (e.g., relay or TRIAC) in an idle state (i.e., in an open state and not drawing current through the coil that controls the relay). According to one implementation, a processor of the primary switch power adapter having a voltage comparator could be used, in which case it would only be necessary for a processor to detect the presence of a switching control module.

One example of detecting the presence of a switching control module includes detecting a voltage signal, such as a voltage signal (e.g., 5 Volt DC signal) generated on the SW contact element of any switching control module. That is, the voltage signal is provided on the SW contact provided by the switching control module (i.e., a DC Switch Signal) to enable the single pole switch to detect a toggling of the switch of the single pole switch power adapter such as the power adapter shown in FIG. 21. According to one implementation, the voltage on the SW contact of the primary switch power adapter could be detected, such as by using the processor of the primary switch power adapter. If the DC Switch Signal is detected by the processor of the primary switch power adapter, it will know that the primary switch power adapter has received a switching control module, where the switching element (e.g., a relay or TRIAC) of the primary switch power adapter may be kept in an idle mode to avoid drawing any current, such as by disabling the operation of the switching element because the switching element is not used for providing controlling the application of power to the load.

According to another example, because a switching control module may include a projection that will open a connector (e.g., electrically separate two contact elements of a “break connector”), a comparator, such as a comparator of a processor, can be used to detect when the two contact elements are at the same voltage (e.g., when they are connected), or when they are at a different voltage (e.g., when a projection of the switching control module “opens” the connector and the two contact elements may be at a different voltage (e.g., the SW contact will be at 5 V DC and the LD contact will be floating, or at 120V AC or some other AC or DC voltage)). Accordingly, when a primary switch power adapter detects the presence of a switching control module, it will maintain the state of its relay in a fixed state, such as an open state (i.e., non-conducting) because it will not control the application of power to a load.

Considering now a switching control module, a switching control module may function to switch power to a load in two cases (i.e., when a switching control module is used in a single pole switch power adapter, or in a primary switch power adapter of a multi-way switching arrangement), but will not function to switch power to a load in a third case when the switching control module is used in a companion switch power adapter. In this case, the switching control module would only need to detect when the switching control module is in the companion switch power adapter. That is, the default mode of the switching control module would be to perform the switching of the power to the load, and the switching control module would enter a non-default mode of providing signaling on the traveler, but not switching its relay.

One way to accomplish this would be to put a voltage signal (e.g., a 1 or 2 V DC signal (i.e., a “DC Offset Signal”)) on the SW contact element of the companion power adapter that is different than the voltage signal (e.g., the 5 V DC signal) applied to SW contact by the switching control module as described above, where the 5 V DC signal may be used to indicate a switching operation of the switching element of the power adapter. That is, before the voltage signal (e.g., the 5 V DC signal) is applied to the SW contact by the switching control module, the processor of the switching control module may enter a start-up mode when the switching control module is placed in a power adapter and the switching control module receives power (or after a loss of power and the switching control module receives power again). If the switching control module detects the DC Offset signal, it may change from the default operating mode that would allow its relay to switch to an inactive operating mode (a signal only mode) where the relay would be held in an idle state (i.e., not conduct any current in the coil or through the relay), but would send signals on a traveler.

Alternatively, a voltage signal could be provided on the load (LD) contact, rather than on the SW contact. It should be noted that the SW and LD contacts may not otherwise be required in the companion switch power adapter, but could be included to enable a detection by a switching module that it is in a companion power adapter.

As will be described in more detail below, a signal could be provided on the traveler to detect a wiring error. While the voltage signal could be provided on the traveler (TR) contact element, it may be beneficial to put a DC Offset Signal on the TR contact element for enabling the identification of a wiring error, as will be described below.

When the switching control module detects the DC Offset Signal, the switching control module will determine that it is in a companion switch power adapter. That is, there will never be a 1 or 2 V DC signal (i.e., a DC Offset Signal) on the SW contact of the single pole switch because it is a switching control module itself that applies a voltage to the SW contact, which would only occur after a start-up mode. Also, a voltage will only be placed on the SW contact of a companion switch power adapter, but not a primary switch power adapter to enable the control module to determine that it is in the companion switch power adapter.

According to some implementations, in the default mode, a switching control module may not need to put a control signal on the traveler. There is no need to place a switching signal of a contact of the power adapter when a switching control module is used in a single pole switch application. When a switching control module is used in a primary switch power adapter, there may also be no need to place a switching signal on the traveler when the control module in the primary switch power adapter performs the switching. When the switching control module is used in a companion switch power adapter (i.e., the non-default condition) it may be beneficial for the switching control module to place a switching signal on the traveler to be detected by the processor of the primary switch power adapter. Therefore, according to some implementations, a control module will act as a switching module in a default mode (e.g., such as when in a single pole switch or a companion multi-way switch, or a signaling module in a secondary mode (e.g., a non-default mode, such as when in a companion switch power adapter).

It should be understood that a second default case could be implemented where the relay of the switching control module could be in an idle mode as a default mode (i.e., always in an open state to not provide a current path or otherwise draw current), and only be switched to an active mode when it is determined that it is in either a single pole switch power adapter or a primary switch power adapter.

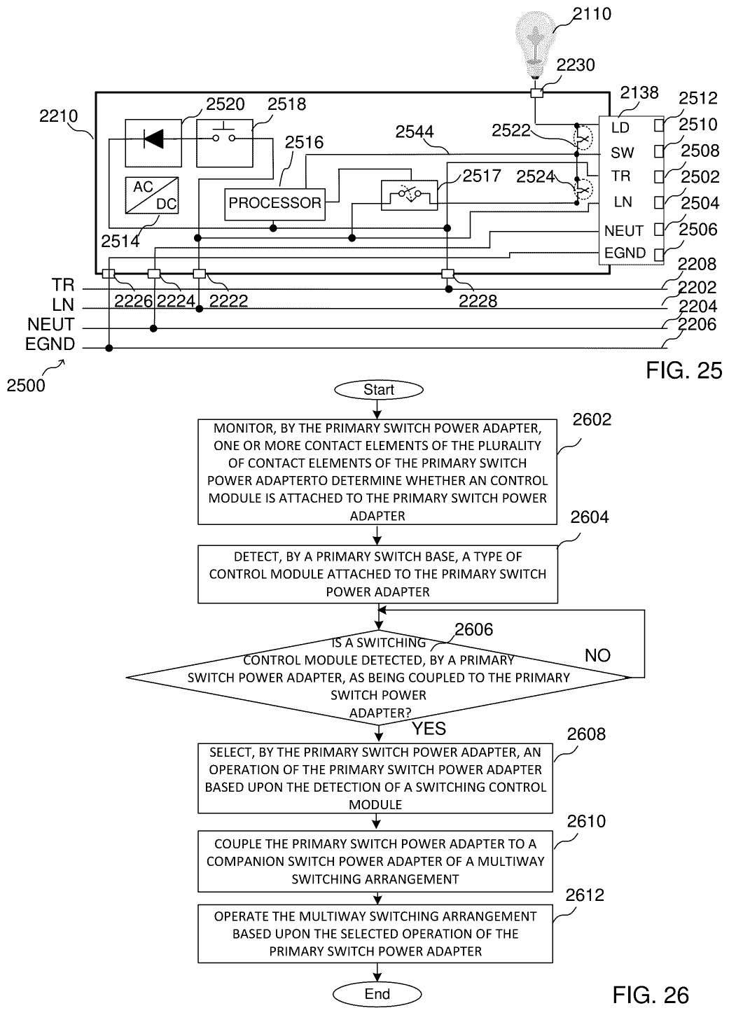

According to another implementation, the relay of a primary switch power adapter may perform the switching when a switching control module is in the primary switch power adapter, where the relay in the switching control module would be held in an idle state (i.e., non-conducting), as will be described in more detail below in reference to FIGS. 25-28.

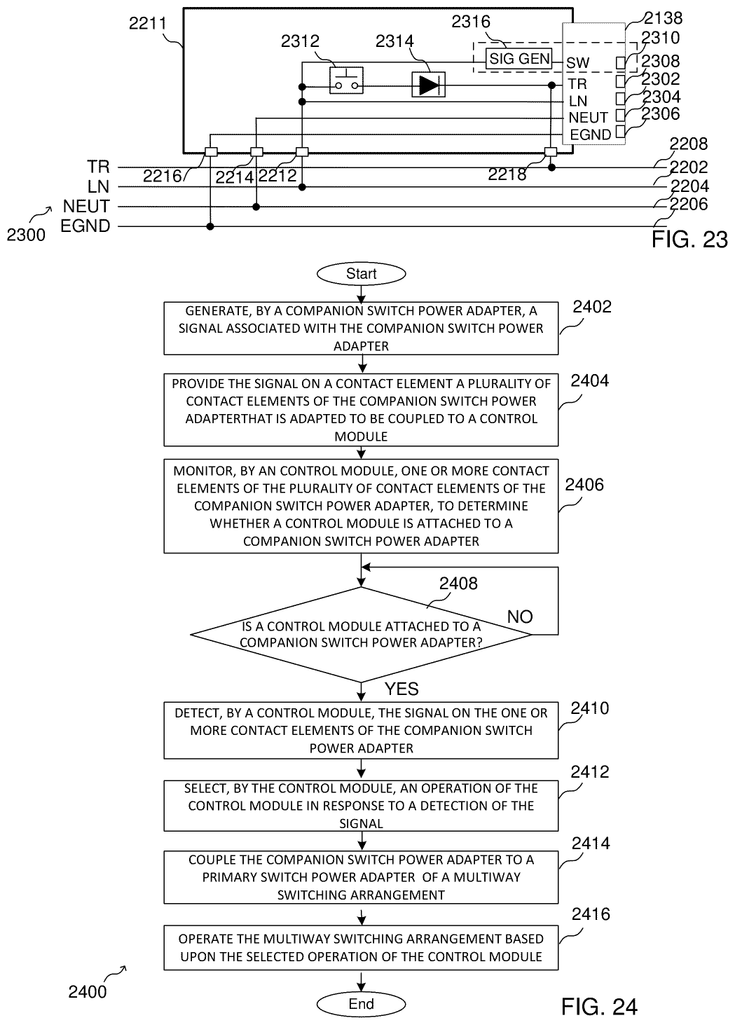

Turning now to FIG. 23, a block diagram of a power adapter 2211 configured to be implemented as a companion switch power adapter as a part of a multi-way wiring arrangement 2300 is shown. More particularly, the electrical interface 2138 comprises a plurality of contact elements adapted to receive corresponding contact elements of a control module, and include a first contact element 2302 adapted to be coupled to a line (LN) contact element of a control module, a second contact element 2304 adapted to be coupled to a neutral (NEUT) contact element of a control module, a third contact element 2306 adapted to be coupled to a ground (EGND) contact element of a control module, a fourth contact element 2308 adapted to be coupled to a traveler (TR) contact element of a control module, and a fifth contact element 2310 adapted to be coupled to a switch (SW) contact element of a control module. The contact elements 2302-2308 are also coupled to corresponding contact elements 2212-2218 to receive the line, neutral, ground and traveler signals as shown.

The power adapter 2211 also comprises a switch 2312, which may be accessible by a user, and provides a signal to a diode 2314. The diode 2314 generates a signal in response to the actuation of the switch 2312. The signal is provided on the traveler contact element 2218 and the contact element 2308, which may also be a traveler contact element. Signal Generator 2316 is adapted to generate a signal on the contact element 2310, enabling a control module coupled to the electrical interface 2138 to determine that it is coupled to a companion switch power adapter, as will be described in more detail below.

Turning now to FIG. 24, a flow chart 2400 shows a method of implementing a power adapter as a companion switch power adapter in a multi-way wiring arrangement, such as the power adapter of FIG. 23. More particularly, a signal associated with a companion switch power adapter is generated by the companion switch power adapter, such as by the signal generator 2316, at a block 2402. The signal is provided on a contact element, such as contact element 2308, of a plurality of contact elements of the companion switch power adapter that is adapted to be coupled to a control module at a block 2404. One or more contact elements of the plurality of contact elements of the companion switch power adapter is monitored by a control module to determine whether a control module is attached to a companion switch power adapter at a block 2406. It is then determined whether a control module is attached to a companion switch power adapter at a block 2408. If a control module is attached, the signal on the one or more contact elements of the companion switch power adapter is then detected by a control module at a block 2410. An operation of the control module is selected by the control module, such as by a processor of the control module in response to a detection of the signal at a block 2412. The companion switch power adapter is coupled to a primary switch power adapter of a multi-way switching arrangement at a block 2414. The multi-way switching arrangement is operated based upon the selected operation of the control module at a block 2416.

Turning now to FIG. 25, a block diagram of a power adapter 2500 implemented as a primary switch power adapter in a multi-way wiring arrangement is shown. More particularly, the electrical interface 2138 comprises a plurality of contact elements adapted to be coupled to contact elements of a control module, including for example a first contact element 2502 adapted to be coupled to a line contact element, a second contact element 2504 adapted to be coupled to a neutral contact element of a control module, a third contact element 2506 adapted to be coupled to a ground contact element of a control module, a fourth contact element 2508 adapted to be coupled to a traveler contact element of a control module, a fifth contact element 2510 adapted to be coupled to a switch contact element of a control module, and a sixth contact element 2512 adapted to be coupled to a load contact element of a control module. The contact elements 2502-2508 are coupled to corresponding contact elements 2222-2228 to provide the line, neutral, ground and traveler signals to the control module.

The power adapter 2210 comprises a power supply 2514, shown by way of example as an AC-to-DC converter. The DC signal generated by the power supply 2514 is adapted to provide power to the elements of the power adapter 2210. The power adapter also comprises a processor 2516 adapted to detect signals from a switch 2518 that are routed through a diode 2520 as shown. The signal may indicate that a user desires to change the state of the power to the load for example. The processor controls a switch 2517 for routing the line power to the load. The switch 2517 may be a relay or a TRIAC for example. Connectors 2522 and 2524 enable different operations of the power adapter 2210 depending upon the type of control module coupled to the power adapter, as will be described in more detail below. A signal line 2544 is provided from the contact element 2510 to the processor to enable the processor to determine a type of control module, such as a switching control module, that is coupled to the electrical interface 2138. Implementations for detecting a type of control module will be described in more detail below.

Turning now to FIG. 26, a flow chart shows a method of implementing a power adapter as a primary switch power adapter in a multi-way wiring arrangement. The method may be implemented by the circuit of FIG. 25 or some other suitable circuit. More particularly, one or more contact elements of the plurality of contact elements of the primary switch power adapter is monitored by the primary switch power adapter, such as by a processor of the power adapter, to determine whether a control module is attached to the primary switch power adapter at a block 2602. A type of control module attached to the primary switch power adapter is detected by a primary switch power adapter at a block 2604. It is then determined whether a switching control module is detected, by a primary switch power adapter, as being coupled to the primary switch power adapter at a block 2606. An operation of the primary switch power adapter is selected by the primary switch power adapter based upon the detection of a switching control module at a block 2608. The primary switch power adapter is coupled to a companion switch power adapter of a multi-way switching arrangement at a block 2610. The multi-way switching arrangement is operated based upon the selected operation of the primary switch power adapter at a block 2612.

According to one implementation, a switching circuit of one of the primary switch power adapter and a switching module will remain idle and allow the switching circuit of the other of the primary switch power adapter and a switching module control the application of power to the load. For example, when the primary switch power adapter detects that it is coupled to a switching module, the processor of primary switch power adapter may maintain the switching circuit (e.g., relay or TRIAC) of the primary switch power adapter in an idle state and allow the control module to control the application of the power signal to the load. Alternatively, when the primary switch power adapter detects that it is coupled to a switching module, the processor of primary switch power adapter may instruct the switching circuit (e.g., relay or TRIAC) of the control module to remain idle.

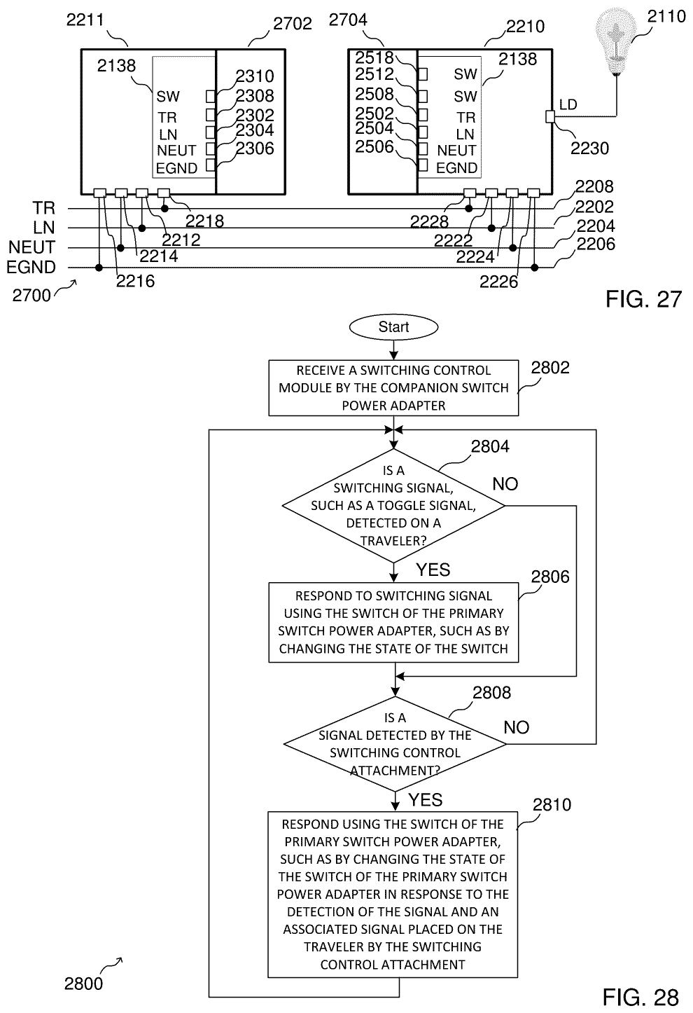

Turning now to FIG. 27, a block diagram of a pair of power adapter arrangements 2700 configured in a multi-way wiring arrangement according to one implementation is shown. According to the example of FIG. 27, a switching control module 2702, which may be adapted to route line power to the load in some power adapters, is coupled to the power adapter 2211, and a non-switching control module 2704, which may be a control module that draws power from the power adapter but does not directly control the application of power to a load by routing the power to the load, is coupled to the power adapter 2210.

Turning now to FIG. 28, a flow chart 2800 shows a method of implementing a pair of power adapter arrangements according to the multi-way wiring arrangement of FIG. 27. More particularly, a switching control module is received by the companion switch power adapter at a block 2802. It is then determined whether a switching signal, such as a toggle signal, is detected on a traveler at a block 2804. If so, the primary switch power adapter responds to switching signal using the switch of the primary switch power adapter, such as by changing the state of the switch at a block 2806. If a switching signal is not detected at block 2804 or after responding to the switching signal at block 2806, it is then determined whether a signal is detected by the switching control module attached to the companion switch power adapter at a block 2808. If so, the primary switch power adapter responds using the switch of the primary switch power adapter, such as by changing the state of the switch (i.e., the relay or TRIAC) of the primary switch power adapter in response to the detection of the signal and an associated signal placed on the traveler by the switching control module at a block 2810. By way of example, the signal detected be a switching control module would be a signal generated in response to a user actuation of a user interface element of the control module or a signal, such as a wireless signal, received by the switching control module. If a signal is not detected by the switching control module at block 2808 or after a response at block 2810, it will again be determined whether a switching signal is detected on a traveler at block 2804.

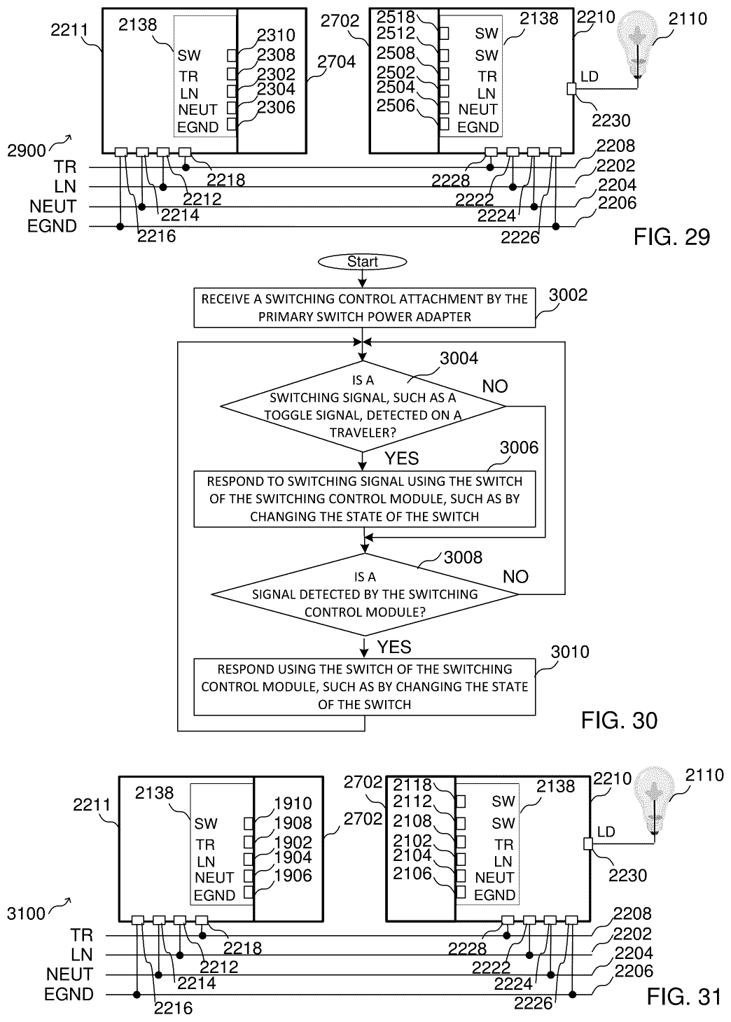

Turning now to FIG. 29, a block diagram of a pair of power adapter arrangements 2900 configured in a multi-way wiring arrangement according to another implementation is shown. According to the example of FIG. 29, a switching control module 2702 is coupled to the power adapter 2210, and a non-switching control module 2704 is coupled to the power adapter 2211. As will be described in more detail below, the switching control module 2702 may route power to a load when coupled to a primary switch power adapter.

Turning now to FIG. 30, a flow chart showing a method of implementing a pair of power adapter arrangements according to the multi-way wiring arrangement of FIG. 29 is shown. More particularly, a switching control module is received by the primary switch power adapter at a block 3002. It is then determined if a switching signal, such as a toggle signal, is detected on a traveler at a block 3004. If so, a response to a switching signal using the switch (e.g., relay or TRIAC) of the switching control module, such as by changing the state of the switch, is made at a block 3006. If a switching signal is not detected on the traveler at block 3004 or a response is made at block 3006, it is then determined whether a signal, such as a wireless signal for example, is detected by the switching control module at a block 3008. If so, a response using the switch of the switching control module, such as by changing the state of the switch, is made at a block 3010. If no signal is detected at block 3008 or a response is made at block 3010, it is again determined if a switching signal is detected on a traveler at a block 3004.

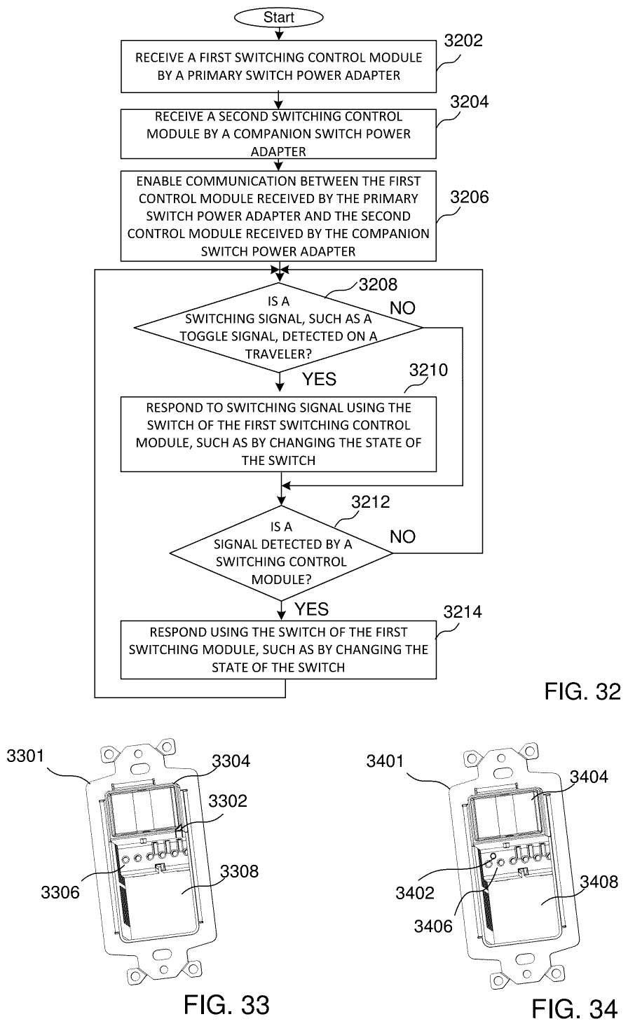

Turning now to FIG. 31, a block diagram of a pair of power adapter arrangements 3100 configured in a multi-way wiring arrangement according to a further implementation is shown. According to the implementation of FIG. 31, switching control modules 2702 are coupled to both the power adapter 2210 operating as a primary switch power adapter and the power adapter 2211 operating as a companion switch power adapter. The operation of and communication between the two switching control modules will be described in more detail below in reference to FIG. 32.

Turning now to FIG. 32, a flow chart showing a method of implementing a pair pf power adapter arrangements according to the multi-way wiring arrangement of FIG. 31 is shown. More particularly, a first switching control module is received by the primary switch power adapter at a block 3202. A second switching control module is received by the companion switch power adapter at a block 3204. Communication between the first control module received by the primary switch power adapter and the second control module received by the companion switch power adapter is enabled at a block 3206. According to some implementations, the communication between the power adapters could be accomplished using wireless communication circuits or over the traveler. It is then determined whether a switching signal, such as a toggle signal, is detected on a traveler at a block 3208. If so, a response to switching signal using the switch of the first switching control module, such as by changing the state of the switch is made at a block 3210. If no signal is detected at block 3210 or a response is generated at block 3210, it is then determined whether a signal, such as a wireless signal detected by one or both of the switching control modules, is detected by the switching control module at a block 3212. If so, a response using the switch of the first switching control module, such as by changing the state of the switch, is made at a block 3214. If no signal is detected at block 3212 or a response is generated at block 3214, it is again determined whether a switching signal is detected on a traveler at a block 3208.

According to some implementations, regardless of the default mode of a control module, a switching control module may operate in a passive mode (i.e., where the relay does not switch, but may still transmit communication signals), but the relay of the primary switch power adapter controls the application of the power to a load. The control module may still send control signals to a processor of the primary switch power adapter which would control the application of power to the load, such as in the circuit arrangements of FIGS. 29 and 31. The signal could be sent over the traveler for example from the control module to the processor of the primary switch power adapter to which the control module is attached, allowing the power switch of the control module to control the application of power to the load, such as in response to a wireless signal received by the control module.

According to some implementations, the primary switch power adapter may communicate over the traveler wire 2208. The primary switch power adapter, whenever it receives a signal from a switching control module, may instruct the switching control module to enter into a passive mode. Any switching control module would function to control the application of power to a load in a power adapter that is adapted to control the application of power to a load in a single pole switch application, such as the single pole switch application of FIG. 21 because the switching power adapter will not receive an instruction from the power adapter of FIG. 21 as shown to enter a passive mode.

According to other implementations, the primary switch power adapter and the switching control module may communicate in a “startup mode” when the switching control module is first inserted in the primary switch power adapter. For example, when a switching control module is first inserted into the primary switch power adapter, the processor of the primary switch power adapter will send a signal over the SW contact element to indicate that it is in a primary switch power adapter, and that it should operate in a passive mode. This operation would be consistent with a switching control module placed in a companion switch power adapter, where the switching control module would detect a voltage on the SW contact element as described above in reference to FIG. 23. That is, the switching control module would operate as a passive control module (i.e., the control module would not control the application of power to the load through its power switch) in either a primary switch control module or a companion switch control module in a multi-way switching arrangement according to this implementation.

Rather than or in addition to (i) a primary switch power adapter of a multi-way switching arrangement identifying the type of control module (and more particularly when a switching control module is placed in the primary switch power adapter), and (ii) a switching control module determining when it is in a companion switch power adapter of a multi-way switching arrangement, some implementations could include communication between primary and companion power adapters, where different signaling may be used based upon the elements of a multi-way switching arrangement. For example, different signals may be generated by a switch power adapter or a control module used in a switch power adapter, where the signal would identify that it is generated by certain element (e.g., signals could have an identification field that could identify that the signal is generated by a primary switch power adapter or a certain type of control module).

According to some implementations, different signals may be sent (i) between a switch power adapter and a control module, and (ii) between different types of switch power adapters (e.g., a primary switch power adapter and a companion switch power adapter).

One consideration for sending different signals from different elements of a multi-way wiring arrangement may be that the primary switch power adapter or a switching control module may need to determine whether a toggle signal is generated by a user toggling the switch on the switch power adapter (which may be an override signal) or a toggle signal is generated from another control module (e.g., a motion detection signal from a motion sensor on a control module in a companion switch power adapter) to correctly decide whether to change the state of the power to the load.

By having the same toggle signaling from the switch of a switch power adapter in a multi-way switch power adapter arrangement and a toggle signal generated by a control module, it may be beneficial that any control module that toggles the state of power to the load be used on the primary switch power adapter. This placement may be beneficial when implementing motion sensor control modules and any type of timer control modules, including a countdown timer, an astronomic timers, and a smart timer for example. That is, a processor of the switch power adapter would not be able to distinguish between a toggle signal generated by the control module and a toggle signal generated by a switch actuator on the switch power adapter.

A switching control module could be any control module that switches line power to a load, such as a motion sensor, an astronomical timer, a countdown timer, a wireless controlled outlet or smart switch having a load switching element, such as a relay or a TRIAC for example. Considering a motion sensor control module, a motion sensor control module may change the state of the light to the wrong state if the control module merely provides a toggle signal (i.e., change of state signal associated with the application of power to a load) that is no different than the toggle signal generated by the actuation of a switch of a switch power adapter by a user of the switch power adapter.

A motion sensor may be set to keep a light on for a predetermined time (e.g., 10 minutes) after detecting motion in a room. If a motion sensor control module is in a companion switch power adapter and detects motion, it may send a toggle signal to the primary switch power adapter or the control module in a primary switch power adapter over the traveler line or by way of a wireless communication link. That is, it will send a first toggle signal to the primary switch power adapter or a control module in the primary switch power adapter to turn the light on and a second signal after the predetermined time to turn the light off. The same is true if the motion sensor control module is in the primary switch power adapter, and it sends a toggle signal on the traveler to the processor of the primary switch power adapter according to some implementations. However, if the signal generated based upon a detection of motion is the same as a toggle signal generated by an actuation of the switch by a user of a switch power adapter, the motion sensor control module may change the state of the light to the wrong state.

For example, if the light is on, and the motion sensor detects motion, it may incorrectly turn the light off if it does not know the state of the switch and just sends a toggle signal because it is in the companion switch power adapter (i.e., by sending a toggle signal to the primary switch power adapter or another switching control module in the primary switch power adapter). A switching control module may know the state of power applied to the light when used in either a single pole switch or a primary switch power adapter when a control circuit of the control module controls the switch (e.g., relay or TRIAC) through which power applied to a load is driven. For example, according to some implementations, the control module may know the state of the power to the load because it controls its relay which applies the power to the load when it is in a single pole switch power adapter or the primary switch power adapter (i.e., when the control module is operating in the default state where the control module controls the application of power to the load as described above).

Further, if a toggle signal is received by a processor of the primary switch power adapter, it may need to know that the toggle signal was from the control module (i.e., at the end of a timeout period), rather than from a toggling of the switch of the switch power adapter.

If the user changes a state of a switch using a switch actuator of the power adapter during a timeout period (i.e., the period from turning the light on to turning the light off in response to the detection of a motion), a toggle signal at the end of the timeout period which is intended to turn the light off will actually turn the light on. If the processor of the primary switch power adapter knows that the light was turned off during the timeout period and receives a toggle from the timer control module, it may not know to maintain the off state, but rather may toggle the switch on. Although examples have been given for a motion detector control module, the same switching issues may apply to any timer control module. When switching control modules are placed in both the primary switch power adapter and a companion switch power adapter, the switching control modules can communicate to control switching and provide user interface information.

According to other implementations, it may be beneficial for a toggle signal from a switch of a power adapter to be distinguishable from a toggle signal from a control module. According to some implementations, distinct signals can be transmitted for a toggle signal from the switch of switch power adapter (e.g., a single pulse) and a toggle signal of a control module (e.g., multiple pulses, such as 2 or 3 pulses, and particularly pulses that are faster than someone could toggle a switch of a switch power adapter). Because a control module may have a printed circuit board and a processor, it can send a signal that may be different from a simple signal generated by a single pole switch power adapter in response to an actuation of a switch actuator by a user or generated by a switch of a primary switch power adapter or companion switch power adapter in response to an actuation of a switch by a user.

According to some implementations, different toggle signals can be generated by a toggle switch based upon the type of power adapter in a multi-way arrangement, where toggle signals generated by the power adapters are also different than the signals generated by the control module. For example, a primary switch power adapter could generate two pulses in response to a selection of a switch actuator by a user on a primary switch power adapter, and a companion switch power adapter could generate three pulses in response to a selection of a switch actuator on a companion switch power adapter. Separate signal patterns could also be sent for distinct ON or OFF signals for the different types of switch power adapters.

According to some implementations, distinct toggle signals can be provided from the switch of the switch power adapter and a control module, where the toggle signal from a control module provides an indication whether the primary switch power adapter is to turn the light on or turn the light off. When a switching control module, when used in any of the switch power adapters, will control the switching of power applied to the load, it is possible to send a toggle signal generated by the power adapter, and more particularly, an ON toggle signal or an OFF toggle signal in some circumstances.

According to some implementations, a switching control module can be operated in the same way regardless of the type of switching power adapter where it is placed (e.g., a processor of the control module could send a switching signal on the traveler and switch the switch (i.e., the relay or the TRIAC) of the control module itself. Alternatively, it may be beneficial to not switch a relay when the switching control module will be used in a companion switch power adapter, because it will not switch power to the load and may unnecessarily draw current through the coil that controls the relay.

According to some implementations, a multi-way switching arrangement can be implemented to enable the control module to identify where it is located, which may affect the operation of the control module, particularly where the control module sends a signal or performs a switching of a switch of the control module based upon where it is located (i.e., in what type of switch power adapter it is located).

For example, in the case of a control module in a single power adapter, it may not be necessary that the switching control module know that it is in the single pole switch power adapter. According to one implementation, a switching control module can have a default mode, where the switching control module will both send a switching signal on the traveler and control the switch of the control module (i.e., the relay or the TRIAC) to route current through the control module. Alternatively, in a default mode, the switching control module may only switch its relay, but not send a control signal. As will be described in more detail below, multiple switching control modules that operate in a default mode can be used in a multi-way switching arrangement. According to other implementations, a switch of a control module in a multi-way switching arrangement can operate based upon the type of switch power adapter in which it is placed.

When considering a multi-way switching arrangement according to some implementations, in addition to the default condition being that a switching control module will both switch a relay of the control module and send a switching signal, only one condition may need to be identified, which is when the control module is in the primary switch power adapter. That is, because the primary switch power adapter has a processor, it may detect whether a switching control module is coupled to the primary switch power adapter.

According to some implementations, a switch power adapter may detect a switching control module based upon an electrical condition. For example, a processor of a power adapter may detect when a switching control module is inserted based upon the use of projections that will break an electrical connection (e.g., a break connector as will be described in more detail below).

According to some implementations, a processor of a power adapter may detect a switching control module based upon a mechanical condition. For example, a switching control module and a primary switch power adapter may be coupled such that a switching control module may engage a switch of the primary switch power adapter to indicate to the processor of the primary switch power adapter that the control module is a switching control module, or conversely a non-switching control module may engage a switch to indicate that the control module is not a switching control module.

It may be beneficial for a processor in a primary switch power adapter to determine that it is receiving control signals from a switching control module that is in a companion switch power adapter. If a processor does not determine that a switching control module is in the primary switch power adapter, it can communicate over the traveler to the switching control module and indicate that the switching control module is in a companion switch power adapter, in which case the switching control module would not need to toggle its relay. Whenever the switching control module is removed or power is lost, it could return to a default state. When power is returned, the processor of the primary switch power adapter would again determine the location of the switching control module.

If switching control modules are in both the primary switch power adapter and a companion switch power adapter, the switching control modules can communicate with each other. If a switching control module determines that it is in the companion switch power adapter, it can send a signal on the traveler to the other switching control modules to indicate that they are companion switching control modules. According to some implementations, if the switching control module is in a primary switch power adapter, it can provide signals to the other control modules that it is the master control module, and the other control modules are controlled by the master control module.

The switching control modules could also include circuits which could detect currents or voltages to determine whether current is being driven by the relay when the relay is closed (i.e., able to drive current). If the switching control module is not driving current, it can determine that it is in a companion switch power adapter, and therefore would only send command signals and keep the relay in an idle state (i.e., the relay is open and therefore not conducting current).

The control modules can send its own signals that identifies it as the sender of a signal, which would help identify whether a switching signal is received from another control module than the control module that is in the primary switch power adapter and performing the switching.

The control modules can be implemented to determine the state of power applied to a load. For example, a control module that determines that is used for switching the power to the load (i.e., in a single pole power adapter or in a primary switch power adapter) can toggle its switch (e.g., a relay or TRIAC) rather than just sending a switching signal on the traveler (i.e., as a control module in a companion switch power adapter would operate). The switch on the power adapter could also send dedicated ON or OFF signals rather than a simple toggle (i.e., change of state signal).

A user can set whether a switching control module is in a primary switch power adapter or companion switch power adapter on the control module itself, for example using a manual slide switch on the control module (i.e., slide between a primary setting or a companion setting) enabling a user to select a master functionality or a companion functionality for the switching control module.

According to another implementation, the switching control modules can detect current passing through the relay when the relay is closed, enabling the switching control module to determine that it is in a primary switching power adapter.

Turning now to FIGS. 33-38, various power adapters may be implemented to enable a user of the power adapter to identify the type of power adapter, which may be necessary for the user to place a control module in the correct power adapter for the control module to operate properly. According to some implementations, it may be beneficial to place a certain type of control module in a certain type of power adapter. That is, both a manufacturer of power adapters and control modules and a homeowner may benefit from an inexpensive and reliable designation of a power adapter type for single pole, primary and companion switch power adapters, and flexibility in using control modules.

Because all three types of switch power adapters (i.e., a single pole power adapter and a primary switch power adapter and companion switch power adapter of a multi-way system) are different, a manufacturer can provide an indication on the power adapter of the type of power adapter, which benefits both an electrician during the installation process and a homeowner in using a system having modular switches and outlets. According to one implementation, the manufacturer can apply a sticker or other designation such as through the use of a printing technique on the switch power adapter that would be visible to the homeowner to indicate the type of switch power adapter. It should be noted that, if the switch power adapters were not different or not designated as being different, it would be necessary for a home builder to rely upon an electrician installing the switch power adapters to indicate the function of the switch power adapter. According to another implementation, if the inside of the switch power adapter is white plastic, the type of power adapter could be in raised black letters for example, which would make it clear what type of power adapter it is.

According to some implementations, an indicator element, such as an LED could provide light to a light guide in the housing of a switch power adapter. A single pole switch power adapter may not have any type of LED because of the expense associated with implementing the LED. However, an LED could be more easily implemented in a primary or companion switch power adapter if they have a printed circuit board. The LED may provide a certain color indicating the type of switch power adapter, or lead to a “lens” that will indicate “Primary” or “Companion” for example. That is, rather than having a light guide from an LED to a small lens on the power adapter housing, a larger lens with “Primary” or “Companion” written on it could be used. For example, the lens could be clear plastic with black lettering indicating “Primary” or “Companion”. The switch power adapter manufacturer benefits by being able to provide a clear indication that a switch power adapter in a multi-way circuit is a primary switch power adapter or a secondary switch power adapter. A lighted “power adapter-type lens” is not only permanent, but very clear to a homeowner.

By providing a lighted power adapter-type lens, the manufacturer can provide a single control module in a situation where a control module is to be used in the primary switch power adapter (e.g., a dimmer in a primary switch power adapter). For example, the manufacturer can provide low-cost simple dimmer control modules. If the manufacturer is not able to easily and reliably provide an indication of the type of power adapter to the homeowner, the manufacturer may determine that it is beneficial to the homeowner to provide the homeowner with different dimmer control modules that would be inserted in each of the bases of a multi-way switching arrangement (e.g., a first dimmer module to be used in a primary switch power adapter that controls power to the load and a second dimmer module for a companion switch power adapter that provides dimming control signals to the first dimmer module). However, such a solution may be costly for both the manufacturer to stock separate modules and inconvenient for the homeowner who would lose the flexibility of being able to move dimmer modules to different locations. If the manufacturer can provide a cheap, reliable, homeowner-friendly indicator of the primary switch power adapter and companion switch power adapters, the manufacturer may be confident that there will be no customer confusion for placing the dimmer module at a particular location in a multi-way circuit.

Further, the homeowner benefits by only having to buy one control module, rather than a pair of control modules, when a control module is required to be placed in a certain location (e.g., a dimmer control module that needs to be in a primary switch power adapter). This solution also relates to a 4-way switching arrangement for a dimmer control module for example. If the manufacturer does not provide a designation of the primary switch power adapter, it would be necessary for the manufacturer to rely upon a homeowner to move the dimmer control module around to find the right location of the primary switch power adapter to receive the dimmer control module, or buy the same number of dimmer control modules as the number of power adapters (e.g., 3 dimmers for a 4-way switch).

According to some implementations, the multi-way switch designation and an error detection indicator can be a part of the same LED/Light guide (e.g., the light guide to the power adapter-type lens, where the error detection would be indicated by color of the LED, such as green for correctly wired and red for incorrectly wired for example), as will be described in more detail below.

According to one implementation, a low-cost option would be to put one or more LEDs (e.g., separate error detection and power adapter-type designation or one LED for combined error detection) in the primary switch power adapter only. In this case, it may be beneficial to provide a clear indication of the type of power adapter for a single and companion switch, even if it is just with a sticker or some other marking. Optimally, an LED would only be lit when there is an error.

Turning first to FIG. 33, a perspective view of a power adapter 3301 having an external indicator element 3302 is shown. The power adapter may comprise a switch actuator element 3304 and a plurality of contact elements 3306 in a recess 3308 adapted to receive a control module. According to the implementation of FIG. 33, an indicator element 3302, which may be an LED or a light guide for routing light from an LED of the power adapter, may be included to provide a status signal, including for example a status signal associated with a correct or an incorrect wiring condition. It should be understood that the indicator element 3302 may be visible when both a control module is inserted into the recess and the wall plate is attached to the power adapter.

Turning now to FIG. 34, a perspective view of a power adapter 3401 having an internal indicator is shown. According to the implementation of FIG. 33, an indicator element 3402, which may also be an LED or a light guide for routing light from an LED of the power adapter, may be provided in a location that is not visible to the user, such as in a recess adapted to receive a control module, where the indicator element would only be visible when the control module is removed from the recess. The indicator element may be included to provide a status signal, including for example a status signal associated with a correct or an incorrect wiring condition. The power adapter 3401 may also comprise a switch actuator element 3404 and a plurality of contact elements 3406 adapted to receive contact elements of a control module received in a recess 3408. While the power adapters 3301 and 3401 are shown by way of example, it should be understood that the implementation and the features of the power adapters would be implemented differently.

Most electricians may be familiar with wiring conventional 3-way switches, where power signals are transmitted over 2 travelers, but may not be as familiar with wiring a 3-way switch or other multi-way switch using a single traveler to send communication signals. Unlike wiring a conventional 3-way switch where the 2 travelers can be connected to either of the 2 traveler contacts of the switches, in an arrangement having a single traveler, such as in the 3-way switching arrangement of FIG. 22 for example, the single traveler wire must be connected to the single traveler contact on each of the primary switch power adapter and the companion switch power adapter in the multi-way switching arrangement. A potential wiring error may arise because of the color of the wires in a wiring bundle used by an electrician. That is, it may be the case that both the wire for routing line power to the primary switch power adapter and to the companion switch power adapter and the wire for connecting the traveler connectors may be the same (e.g., both may be black).

According to some implementations, circuits can be provided in one or both of the primary switch power adapter and the companion switch power adapter for detecting an improper wiring condition.

According to some implementations, circuits can be provided in one or both of the primary switch power adapter and the companion switch power adapter for detecting a high voltage condition where the traveler contact element is connected to line power.

According to some implementations, circuits can be provided in one or both of the primary switch power adapter and the companion switch power adapter for detecting a low voltage condition where the traveler contact element is connected to a neutral or ground voltage.

According to some implementations, a DC signal can be provided on the traveler to enable detecting when the traveler is grounded. That is, unless the DC signal is detected, the traveler contact element nay be determined to be grounded.

According to some implementations, circuits can be provided in the primary switch power adapter that will detect a wiring error on the traveler, and send a signal to the companion switch power adapter indicating an error. The error signal could be sent wirelessly or as a sub-carrier signal on the traveler wire.

According to some implementations, a common wiring error may be on the traveler, where the traveler is pulled to 120 V or ground/neutral. However, circuits could also be provided for detecting other wiring errors.

According to some implementations, an indicator element, such as an LED, could be provided to indicate an error. The LED could be on the switch portion so that it is visible to a homeowner when the control module is removed, or could be inside the recess for receiving the control module and visible only when the control module is removed, as described above in reference to FIGS. 33 and 34. The LED could be a multi-color LED, where the color of the light emitted when there is a wiring error could indicate the type of wiring error, and/or could blink to indicate the type of wiring error.

According to some implementations, separate primary and companion switch power adapter error detection solutions could be provided. According to this implementation, the voltage detection circuits in the primary switch power adapter and the companion switch power adapter may act independently. The circuits in each power adapter will independently detect an improper wiring condition, such as based upon a detected voltage of the traveler. The primary switch power adapter does not need to be connected to the companion switch power adapter by the traveler for either of the power adapters to detect a wiring error.

According to some implementations, the circuits for detecting high voltage or low voltage conditions could be the same in both the primary switch power adapter and the companion switch power adapter.

According to some implementations, a high voltage detection circuit may be implemented. For example, a high voltage detection circuit may include a circuit coupled between the traveler and ground or neutral, where current would only flow and turn on an LED when the voltage on the traveler is greater than a predetermined value, indicating that the traveler is improperly wired (e.g., near 120 V or 220 V). The traveler voltage range for sending signals on the traveler may be set to be below 120 V to ensure that an abnormally high voltage on the traveler is detected.

According to some implementations, a low voltage detection circuit may be implemented in place of or in addition to a high voltage detection circuit. For example, a DC voltage applied to the traveler may be set at a level high enough that a low voltage condition (e.g., the voltage level of ground or neutral, which may vary by about a volt), can be detected. That is, a fixed DC voltage applied to the traveler (i.e., a DC offset) can be selected to ensure that a connection of the traveler to either the ground potential or neutral potential can be detected, and provide a circuit to detect when the traveler is at an abnormally low value.

The traveler voltage range may be set above the voltage that may be detected on either the ground or neutral contact to ensure that an abnormally low voltage on the traveler range would be detected. If the difference between the ground and the neutral contact would be 1 V or less, the DC offset on the traveler could be set at 2 V for example, so that when the voltage on the traveler is between 0 and 1 V, it could be determined that the traveler is improperly coupled to either the ground or neutral line rather than the traveler line between the primary switch power adapter and the companion switch power adapter.

According to some implementations, a primary switch power adapter could control the detection of a wiring error. According to this implementation, a voltage detection circuit in the primary switch power adapter may send a signal to the companion switch power adapter by way of the traveler if there is an error. Multiple error detection circuits (e.g., both abnormal high voltage and low voltage detectors) may be provided in the primary switch power adapter.

A detection circuit (for both high and low voltage detection) of the companion switch power adapter may not be necessary, but rather a simple detection circuit for detecting an error signal from the primary switch power adapter on the traveler may be provided. That is, if there is an error detected at the primary switch power adapter, there may be a wiring error for both the primary switch power adapter and the companion switch power adapter. The error detected at the primary switch power adapter can be transmitted to the companion switch power adapter, and displayed on both the primary switch power adapter and the companion switch power adapter.

According to some implementations, an error indication (e.g., an LED emitting red light) could be indicated on the companion switch power adapter if the traveler contacts of the primary switch power adapter and the companion switch power adapter are not connected to each other. That is, the companion switch power adapter will not receive the steady state signal (e.g., a DC offset) if the traveler contacts are not connected by the traveler wire, and therefore an error indication will be provided on the LED.

For example, the primary switch power adapter may provide a signal on the traveler to the companion switch power adapter when the travelers are connected (e.g., 1 or 2 V DC Offset). For example, if an error is detected by one or more detection circuits on the primary switch power adapter, the error signal on the traveler can be provided (e.g., where the traveler is pulled high or low, and an error detection circuit in the companion switch power adapter will detect that signal (i.e., either a high or low signal generated by the primary switch companion base)). The selection of pulling the traveler low or high could be selected based upon which detection circuit is easier to implement. It should also be noted that a voltage detection circuit in the primary switch power adapter may send a signal, other than just pulling the traveler to a high voltage or a low voltage, to the companion switch power adapter.

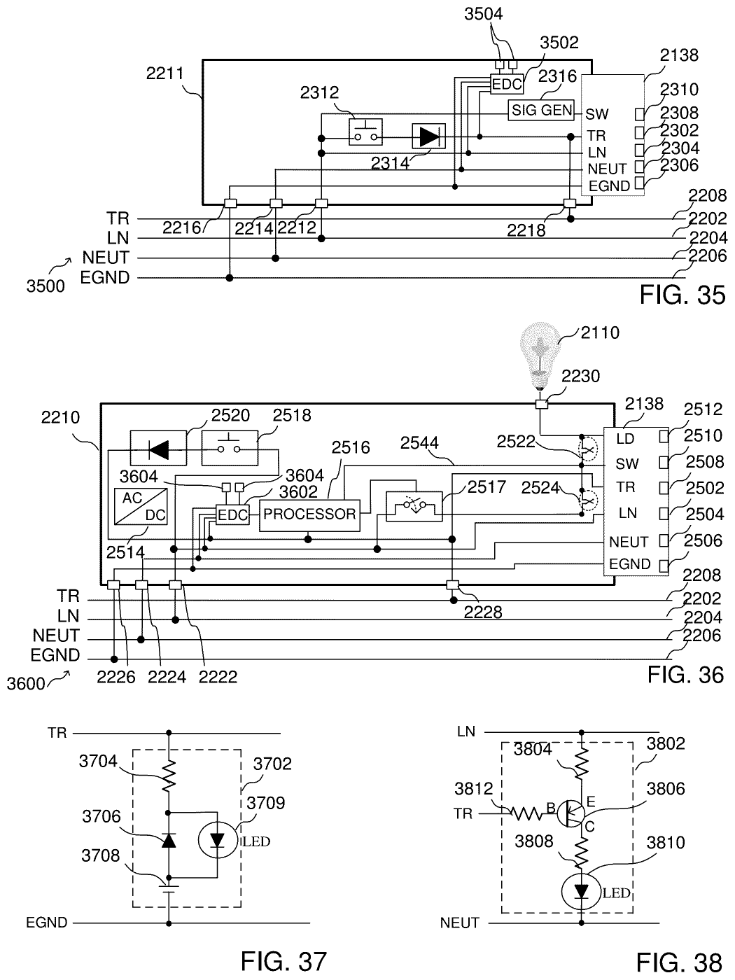

Turning now to FIG. 35, a block diagram of a power adapter 3500 configured to be implemented as a companion switch power adapter in a multi-way wiring arrangement and having an error detection circuit (EDC) is shown. According to the implementation of FIG. 35, an error detection circuit 3502, which may detect a wiring error condition, will be described in more detail below. The error detection circuit may be coupled to indicator elements 3504, which may be implemented as indicator elements 3302 and 3402 as described above. Example functions of the error detection circuit 3502 will be described in more detail below.

Turning now to FIG. 36, a block diagram of a power adapter 3600 configured to be implemented as a primary switch power adapter in a multi-way wiring arrangement and having an error detection circuit is shown. The power adapter 3600 comprises, according to the implementation of FIG. 36, an error detection circuit 3602, that may detect a wiring error condition as will be described in more detail below. The error detection circuit may be coupled to indicator elements 3604, which may be implemented as indicator elements 3302 and 3402 as described above. While two indicator elements 3604 are shown by way of example and may be used to show different error conditions, additional indicator elements could be implemented, or a single indicator element could be implemented, where different colors of a multicolor LED and different flashing patterns could be used to indicate different errors. Example functions of the error detection circuit 3602 will be described in more detail below.

While shown for both the power adapter 2210 and power adapter 2211, it should be understood that the error detection circuit may be implemented in both or in only one of the two switch power adapters to indicate an error in the wiring of the multi-way switching arrangement. According to some implementations, an error detection circuit may send a signal on a traveler line to disable power adapter. According to some implementations, by disabling the power adapter, the power adapter may not function properly, such as preventing power from being applied to a load.

Turning now to FIG. 37, a block diagram of a high voltage detection circuit 3702 that may be implemented in the error detection circuit of FIG. 34 or 35 is shown. The high voltage detection circuit 3702 comprises a series of elements coupled between the traveler and a reference voltage, such as a neutral or ground voltage, including a resistor 3704, a diode 3706 and a capacitor 3708 as shown. An indicator element 3709, shown here by way of example as a light emitting diode (LED) is coupled across the diode 3706.

According to some implementations, the values of the components can be selected to that the current only flows and the LED emits light when the voltage on the TR contact element of the power adapter exceeds a certain value. While the circuit of FIG. 37 is shown by way of example, it should be understood that other high voltage detection circuits could be implemented.

Turning now to FIG. 38, a block diagram of a low voltage detection circuit 3802 that may be implemented in the error detection circuit of FIG. 34 or 35 is shown. A series of elements is coupled between the line contact element and a reference contact element, which may be a neutral or ground contact element, for example. More particularly, a resistor 3804, a transistor 3806, shown here by way of example as a bipolar junction transistor (BJT), a resistor 3808, and an indicator element 3810 are coupled in series between the line contact element and a reference voltage. A resistor 3812 is coupled between the traveler (TR) contact element and a base of the transistor 3806. The values of the components of FIG. 38 could be selected so that if the voltage on the TR contact element that is coupled to the base of the transistor is low, the transistor would turn on and the current in the LED will cause light to be admitted by the LED. That is, the circuit of FIG. 38 could be used to indicate if the traveler is unintentionally pulled to a ground or neutral voltage.

While the circuits of FIGS. 37 and 38 are provided by way of example to show circuits for detecting a low voltage or high voltage respectively, it should be understood that other suitable circuits could be implemented. It should also be understood that the low voltage and high voltage detection circuits can be implemented together with respect to a given node or contact element, and can be implemented with multiple contact elements to enable a comparison of a contact element to a number of different other contact elements to detect any possible wiring error.

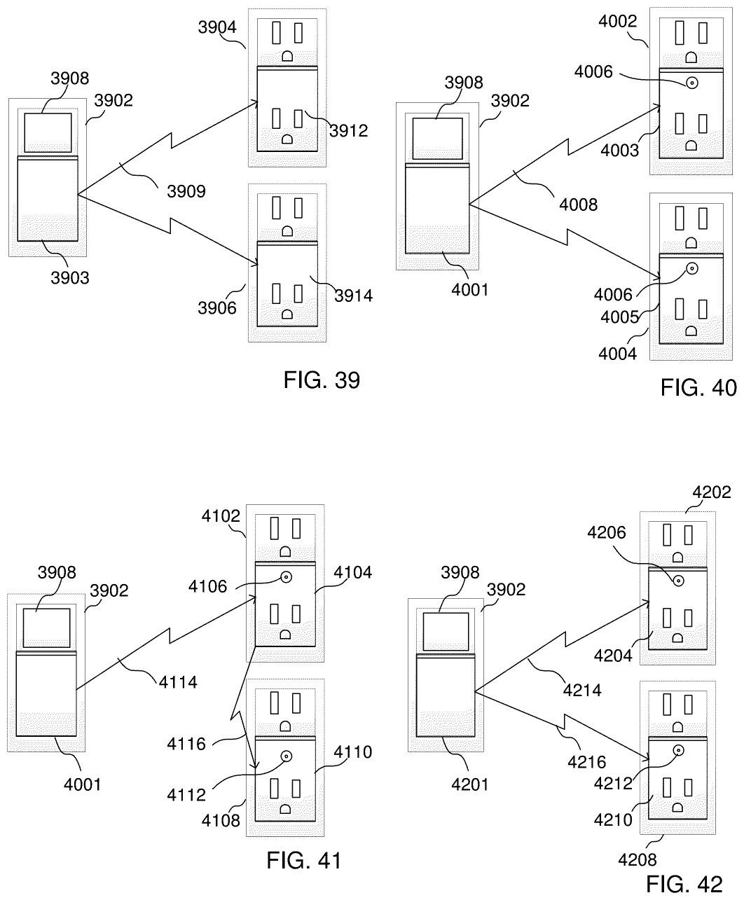

Turning now to FIG. 39, a block diagram of a power adapter configured to control multiple wirelessly controlled outlets using a common toggle signal according to one implementation is shown. A power adapter 3902 having a control module 3903 with a single transmitter is adapted to communicate with multiple wirelessly controlled outlet control modules, shown here by way of example in power adapters 3904 and 3906. The power adapter 3902 comprises a switch actuator 3908 and is configured to receive the control module 3903. According to some implementations, the control module is adapted to provide a single toggle signal 3909 to both a wirelessly controlled outlet module 3912 associated with the power adapter 3904 and a wireless controlled outlet module 3914 associated with the power adapter 3906.

Turning now to FIG. 40, a block diagram of a power adapter configured to control multiple wirelessly controlled outlets using a common on/off state signal according to one implementation is shown. A power adapter 3902 having a control module 4001 with a single transmitter is adapted to transmit a common on/off state signal to multiple wirelessly controlled outlet control modules, shown here by way of example as a power adapter 4002 having a wirelessly controlled outlet 4003 and a power adapter 4004 having a wirelessly controlled outlet 4005. That is, rather than sending a generic toggle signal, the control module sends specific signals 4008, such as “on” or “off” signals or other control commands. The control modules have an on/off control element 4006 that would allow a user to change the state of the power applied to a device plugged into the power adapter, and manually override the state of the power applied to a device.

Turning now to FIG. 41, a block diagram of a power adapter configured to control multiple wirelessly controlled outlets using signaling between wirelessly controlled outlet control modules according to one implementation is shown. According to the implementation of FIG. 41, a toggle or on/off signal may be sent to one control module, and transmitted from the one control module to one or more other control modules. More particularly, the wirelessly controlled outlets may be provided in pairs, where one primary wirelessly controlled outlet is adapted to communicate with one or more remote wirelessly controlled outlets. A power adapter 4102 is adapted to receive a wirelessly controlled outlet module 4104 having a control button 4106, which may comprise an on/off button for controlling/overriding the application of power to a device plugged into the wirelessly controlled outlet 4104. A power adapter 4108 is adapted to receive a wirelessly controlled outlet module 4110 having a control button 4112, which may also comprise an on/off button for controlling/overriding the application of power to a device plugged into the wirelessly controlled outlet 4110. Unlike the implementation of FIG. 40 where the control module in the power adapter having a switch directly communicates with multiple controlled outlet modules in power adapters having outlets, the control module in the switch power adapter communicates with one wirelessly controlled outlet, which in turn communicates with other wirelessly controlled outlets. More particularly, the control module 4001 communicates with the wirelessly controlled outlet 4104 by way of a first communication link 4114, and the wirelessly controlled outlet 4104 communicates with one or more other wirelessly controlled outlets by way of a second communication link 4116.

Turning now to FIG. 42, a block diagram of a power adapter having a control module 4201 configured to control multiple wirelessly controlled outlets using multiple transmitters of the control module according to one implementation is shown. As can be seen, separate transmitters may be used to send different toggle signals or other control signals to corresponding separate control modules. A power adapter 4202 is adapted to receive a wirelessly controlled outlet module 4204 having a control button 4206, which may comprise an on/off button for controlling/overriding the application of power to a device plugged into the wirelessly controlled outlet module 4204. A power adapter 4208 is adapted to receive a wirelessly controlled outlet module 4210 having a control button 4212, which may also comprise an on/off button for controlling/overriding the application of power to a device plugged into the wirelessly controlled outlet 4210. More particularly, the control module 4201 communicates with the wirelessly controlled outlet module 4204 by way of a first communication link 4214, and the wirelessly controlled outlet module 4204 communicates with one or more other wirelessly controlled outlets, shown here by way of example as wirelessly controlled outlet 4210, by way of a second communication link 4216. According to some implementations, a user interface may comprise separate control elements for controlling the separate signals.

Another beneficial application of control modules relates to receiving status information related to garage doors and enabling control of garage doors, The status of the open and closed state of a garage door may be uncertain (as the garage door may not be visible), unless a homeowner makes an effort to look at the door, or opens an app on their phone to check the status. While these options to learn the status may be relied upon by a homeowner at different times, these options may be unreliable, and additional resources to determine the open/closed state of the garage door and change the state may be beneficial. For example, there may be cases where a homeowner may deviate from their normal routine, which may be to check the state of the garage door before they go to sleep at night or checking their phone, such as be using a garage door opener app. If a homeowner relies upon their phone to determine the state of the garage door, there may be circumstances where they do not have their phone with them (e.g., the phone may be connected to a charger or in another room). It may be inconvenient to get their phone, and they may then forget to check the status of the door later when they do get their phone. Although the end of the day may be a common time when a homeowner may wish to know the status of their garage door(s), there are other times when a user may wish to know the status, such as whether a garage door is open or closed at any given time of the day, or even that a garage door is open at a particular time, such as when a friend may be stopping over. Therefore, it is generally inconvenient and potentially unreliable to rely on a routine that does not include an easily visible indicator or a routine that lacks a reliable reminder. The lack of a visible indicator or reliable reminder decreases the likelihood that a homeowner may determine an undesirable state of a garage door.

A garage door opener control module provides a reliable solution to the challenges of both determining the state of one or more garage doors and controlling the state of the garage doors. There are many who may find it convenient to easily see the status of their garage door before they go to bed at night by the use of a control module in a location that a homeowner may easily see. For example, a homeowner may choose to place one or more garage door opener control modules at locations that will increase the likelihood that a homeowner will detect an undesirable state of a garage door. For example, a homeowner may place a garage door opener control module in the kitchen, where the homeowner may often pass through. The homeowner may also place a garage door opener control module in a mud room, where the homeowner would see the state of the garage as they leave the mud room and enter into the living areas of their home, and realize that the garage door was not shut. The homeowner may also place the control module in a light switch, such as a light switch at the top or bottom of a staircase to a second floor. The homeowner may see the status of the garage door as they head upstairs at the end of the day.

Words and/or colors, such as red and green, can be used to provide an easy visual indicator as to the state of a garage door. For example, red could be used to show that the garage door is open, and green to show that it is closed. The color red would indicate an abnormal condition, which would likely be the case when the garage door is opened. However, it should be understood that other colors could be used, or green could be used to indicate that a garage door is open.

Some control modules may, in addition to providing a status, provide control, such as being able to open or close the garage door. That is, when a homeowner sees that a state of a garage door needs to be changed, The homeowner can simply press in up or down button on the control modules.

A microphone for receiving audible commands may be provided. A speaker for providing audible warnings may also be provided. The control module may also be connected to a smart speaker, such as a smart speaker provided by Amazon/Alexa, Google/Nest or Apple/Home Kit.

Garage door opener control modules may include multi-door garage door opener status and/or control for 2, 3 or more garage doors. It should be understood that a touch screen interface or physical interface (i.e., physical buttons) could be used.

For a touch screen interface, the control module could be a multi-mode control module. For example, an analog or digital clock could be shown on the screen when a garage door status is not needed (e.g., the garage door(s) are closed). A homeowner can cursor through modes, such as a clock mode, a blank screen mode, or a garage door status mode, such as by the selection of an actuator on the control module. In either of the clock mode or blank screen mode, the garage door status screen could be shown at certain times (e.g., evening) or when certain conditions exist (e.g., when a garage door is open).

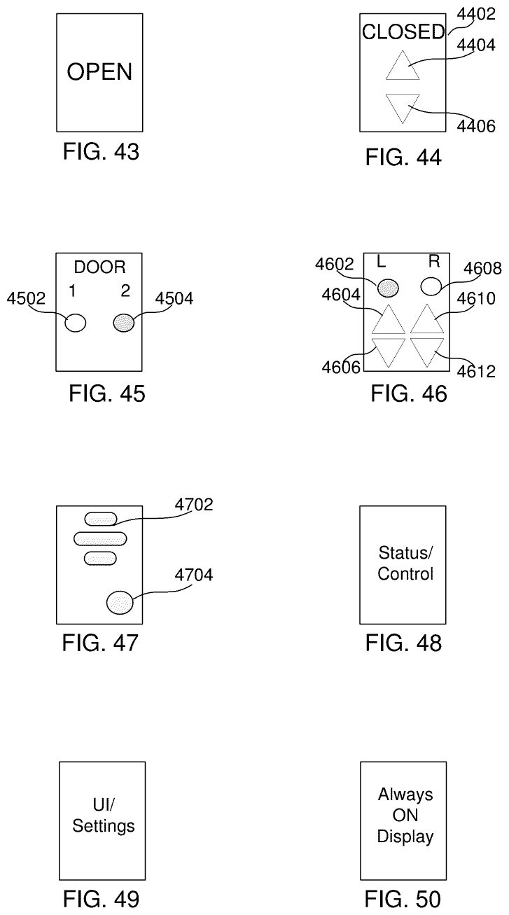

Turning now to FIG. 43, a user interface for a control module adapted to provided status information associated with a door, such as a garage door, is shown. The user interface could be a display which may indicate an open or closed state of the garage door, such as an LED display, or simply an indicator light such as an LED which may indicate the open and closed state of the door. According to some implementations, the indicator light may be a status indicator to indicate the open or closed status of the garage door.

Turning now to FIG. 44, a user interface for a control module adapted to provided status information and a control interface, such as up and down actuators, associated with a door, such as a garage door, is shown. The user interface may comprise one or more control actuators and one or more status indicators. More particularly, the user interface may comprise an information field 4402 that provides information such as a status of the open and closed state of a garage door. The user interface may also comprise a first actuator 4404 enabling a user to open the garage door and a second actuator 4406 enabling a user to close the garage door, where control signals to open or close the door (i.e., an open signal or a close signal) are sent in response to the selection of the actuators 4404 and 4406.

Turning now to FIG. 45, a user interface for a control module adapted to provided status information associated with multiple doors, such as garage doors, is shown. The user interface may comprise a first information field 4502 that indicates the state of a first garage door and a second information field 4504 that indicates the state of a second garage door.

Turning now to FIG. 46, a user interface for a control module adapted to provided status information and a control interface, such as up and down actuators, associated with multiple doors, such as garage doors, is shown. More particularly, the user interface may comprise a first information field 4602 that indicates the state of a first garage door (shown here by way of example as an LED), a first actuator 4604 enabling a user to open the garage door, and a second actuator 4606 enabling a user to close the first garage door. The user interface may comprise a second information field 4608 that indicates the state of a second garage door, a third actuator 4610 enabling a user to open the garage door, and a fourth actuator 4612 enabling a user to close the second garage door.

Another beneficial application of control modules is control modules that interface with camera doorbells. There are a number of problems and costs associated with both traditional doorbells and conventional camera-type doorbells, and corresponding cost savings associated with being able to use control modules that provide functionality associated with doorbells. General problems associated with wired doorbells include (i) the transformer must be wired to both the doorbell and the chime for a conventional wired chime, (ii) the chime must be in a fixed location because it's wired, (iii) there is a limited/inconvenient ability to control the volume/tone of the chime, (iv) because a wired chime is in a fixed location, the volume setting of the chime may not be desirable in different locations in the home (e.g., it's too loud in the hall where they are usually placed, but hard to hear in other rooms in the house), and (v) the doorbell must be integrated with the chime, which generally requires purchasing an adapter from the doorbell provider.

General problems for wireless doorbells include (i) wireless doorbells may not be viewed favorably by homeowners, and typically may be used in aftermarket do-it-yourself (DIY) installs, (ii) wireless doorbells require batteries that must be replaced, which is a nuisance for a home owner, (iii) having a critical part of a home monitoring system relying on batteries is problematic, (iv) current plug-in chimes require a transformer/cord/plug and must be plugged into an outlet, which may be unsightly and limited to outlet locations, where switch locations may be more desirable in many cases, particularly if the chime control module has user interface controls.

Control modules are beneficial for both wired and wireless doorbells. According to one implementation, wired doorbells and wired chimes may be implemented, but control modules would still provide the opportunity to place additional chimes, or possibly other functional control modules associated with the doorbell in additional locations (e.g., a status display control module or a display control module showing a camera view from the camera of the doorbell).

According to another implementation, control modules may be used with a wired doorbell and a wireless chime, which provides many benefits. For example, a home builder has flexibility and reduced labor costs for installing a transformer for a wired doorbell. This is simpler than installing a transformer for a conventional doorbell having a chime, where lines from the transformer have to be routed to both the chime and the doorbell. A homeowner gets the benefit of a wired doorbell, where there is no need to replace batteries on a critical component of a home monitoring system. A homeowner also gets the benefit of placing chimes at multiple locations, and more desirable locations. Unlike chimes that are placed high in the wall in a hall, the homeowner has access to the chime control module, and can easily adjust the tone of the chime and the volume, for example. Also, there are opportunities for integration of the doorbell with Bluetooth speakers or speakers that are a part of an intercom system.

According to a further implementation, control modules can be used with a wireless doorbell and a wireless chime.

A chime control module may have a user interface to easily adjust the tone and volume of the chime, or to easily access other information. Because the chime can be placed in different locations, the chime can be heard in one location, without being too loud in another (i.e., easily heard downstairs without waking a sleeping baby upstairs). A chime control module may include controllable volume and tone for example.

A control module could be provided for cameras, where the status could be always on, or could be set up so that a user could tap on a display to see the status of a camera. A control module could be used to see or check the state of a camera without having to rely on a mobile device. If a camera goes off-line, a message could be displayed on the control module. Some or all communication/control features of the doorbell interface could be provided on the control module for communication or control.

A display control module for a camera could also be provided. This makes it more convenient for a homeowner, who won't always have access to their phone, or don't necessarily pay attention to their phones for certain information. The ability to access certain information in certain locations is beneficial. For example, a user could see a camera view from a control module in a light switch in a bedroom. According to some implementations, the display could be off, and tapped to see the camera view, with an option to swipe the screen to see other camera views if multiple doorbells or cameras are used. For example, a homeowner may have his phone on a charger downstairs, and happens to be upstairs when the doorbell rings. It would be convenient for the homeowner to see who is at the door without having to get their phone or go downstairs.

Turning now to FIG. 47, an example of a control module of a door chime associated with a doorbell camera is shown. The chime may comprise a speaker 4702 and a microphone 4704. It should be understood that the control module could include actuators for controlling the operation of the doorbell camera.

Turning now to FIG. 48, a user interface of a control module that enables determining a status of a doorbell camera and controlling of a doorbell camera is shown. The user interface could comprise indicator lights, a touch screen display, or a combination of indicator lights and a touch screen display. The user interface may also comprise actuator elements, such as actuator buttons.

Turning now to FIG. 49, a user interface of a control module enabling controlling settings of an associated doorbell camera is shown. The user interface could comprise a touch screen display, actuator elements, such as actuator buttons, or a combination of a touch screen display or actuator elements. The user interface may enable a user to set various setting of the doorbell camera and associated control modules (such as associated chime modules). The settings may include, for example, volume control, tone control, zoom settings, chime control, and touchscreen settings.

Turning now to FIG. 50, a control module having a dedicated display is shown. According to the implementation of FIG. 50, a display may be always on to show what is being captured by the door bell camera, or selectable to be off or show what is being captured by the camera.

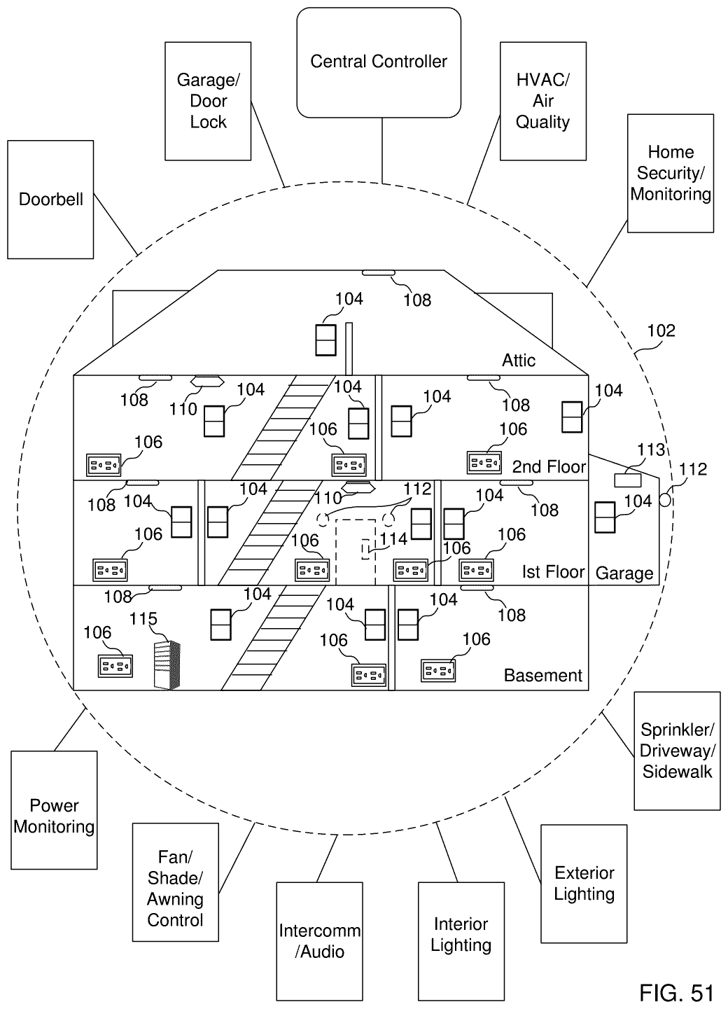

Turning now to FIG. 51, a system for integrating control modules associated with different control functions of a building such as a residential building is shown. The system of FIG. 47 comprises a plurality of different categories of control modules having similar functionality that may interact with each other or with a central controller. According to some implementations, the categories of control modules could include doorbell control modules, garage/door lock control modules, HVAC/air quality control modules, home security/home monitoring control modules, power monitoring control modules (which may include power consumption associated with a given switch or outlet or with solar power generation, storage and usage), fan/shade/awning control modules, intercom/audio control modules, interior lighting control modules, exterior lighting control modules, and sprinkler/driveway and sidewalk control modules to provide sprinkler control and control of the heating of driveways and sidewalks.

According to some implementations, doorbell control modules may include door chimes, cameras, and various control modules having user interfaces for controlling the operation of the doorbell and doorbell control modules, as described above.

According to some implementations, garage/door lock control modules may include status or control modules, as described above.

According to some implementations, HVAC/air quality control modules may include various types of sensors, status and control-type control modules associated with HVAC or air quality systems.

According to some implementations, home security/home monitoring control modules may include cameras, various types of sensors, status and control-type control modules associated with home security or home monitoring systems.

According to some implementations, power monitoring control modules may include status and control-type control modules associated with lighting or electrical outlets for example, and solar power generation, storage and usage.

According to some implementations, fan/shade/awning control modules may include various types of sensors, status and control-type control modules associated with fans or shades and awnings for windows.

According to some implementations, intercom/audio control modules various types of sensors, status and control-type control modules associated with audio or intercom systems in a home.

According to some implementations, interior lighting control modules may include any type of lighting control device, including dimmer control modules, timer control modules, smart switch control modules, smart outlet control modules, for example.

According to some implementations, exterior lighting control modules may include any type of lighting control device, including various sensor control modules, timer control modules, and smart switch control modules.

According to some implementations, sprinkler/driveway and sidewalk control modules may include various sensor control modules, timer control modules, and smart switch control modules.

A beneficial aspect of the system 100 is that the ability to place control modules in a variety of different locations enables various systems, such as systems associated with the various categories of control modules to exchange information or otherwise interact and improve the operation of the individual systems, such as by improving reliability, accuracy, efficiency, or other metrics associated with the system. According to some implementations, all of the control modules may communicate with a central controller, which may communicate with control modules of other systems. The central controller may operate on a particular wireless protocol, such as a cellular protocol, WiFi, Zigbee, Z-Wave, Matter, Thread, Bluetooth, NFC, or some other communication network, such as a proprietary communication network and mesh networks associated with the various protocols. According to some implementations, the central controller may have multiple wireless interfaces. According to other implementations, control modules of different systems may communicate directly with one another. Various external environmental measurements may be determined through external sensors, or through information stored in or acquired from the central controller.

According to some implementations, doorbell control modules may provide information to interact with one or more of the garage/door lock system, home security and monitoring systems, fan/shade/awning systems, intercom/audio systems, interior lighting systems and exterior lighting systems, for example. According to some implementations, a doorbell may include various sensors, which may include for example, temperature and humidity sensors.

According to some implementations, garage/door lock control modules may provide information to interact with one or more of the home security and monitoring systems, intercom/audio systems, interior lighting systems and exterior lighting systems, for example.

According to some implementations, HVAC/air quality control modules may provide information to interact with one or more of the power monitoring system, fan/shade/awning control system, intercom/audio systems, interior lighting systems and exterior lighting systems, for example.

According to some implementations, home security/home monitoring control modules may provide information to interact with one or more of an/shade/awning control system, intercom/audio systems, interior lighting systems, exterior lighting systems, and the sprinkler/driveway/sidewalk system, for example.

According to some implementations, power monitoring control modules may provide information to interact with one or more of the interior and exterior lighting systems, for example.

According to some implementations, fan/shade/awning control modules may provide information to interact with one or more of the home security/monitoring systems, intercom/audio systems and interior and exterior lighting systems, for example.

Further aspects of the disclosure are provided by the subject matter of the following clauses:

A modular door lock adapted to be attached to a door, the modular door lock comprising a bolt adapted to be received by a door frame; an interior lock portion comprising a first latch element adapted to control a movement of the bolt; and an exterior lock portion comprising a key actuator adapted to control a movement of the bolt; wherein the interior lock portion comprises a module that is removably coupled to the interior lock portion.

The modular door lock of any of the proceeding clauses, wherein the interior lock portion comprises a user interface.

The modular door lock of any of the proceeding clauses, wherein the user interface comprises at least one of a keypad having physical keys, a touchscreen, a touchscreen device enabling an electronic keypad, a sensor, a camera, a display, a speaker, and a microphone.

The modular door lock of any of the proceeding clauses, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

The modular door lock of any of the proceeding clauses, wherein the exterior lock portion comprises a user interface comprising at least one or a keypad having physical keys, a touchscreen, a touchscreen device enabling an electronic keypad, a sensor, a camera, a display, a speaker, and a microphone.

The modular door lock of any of the proceeding clauses, further comprising a cover that is removably attached to the interior lock portion to cover the module.

The modular door lock of any of the proceeding clauses, wherein the module comprise one or more detachable modules.

A modular door lock adapted to be attached to a door, the modular door lock comprising a bolt adapted to be received by a door frame; an interior lock portion comprising a first latch element adapted to control a movement of the bolt; and an exterior lock portion comprising a key actuator adapted to control a movement of the bolt; wherein the exterior lock portion comprises a module that is removably coupled to the exterior lock portion.

The modular door lock of any of the proceeding clauses, wherein the exterior lock portion comprises a user interface.

The modular door lock of any of the proceeding clauses, wherein the user interface comprises at least one of a keypad having physical keys, a touchscreen, a touchscreen device enabling an electronic keypad, a sensor, a camera, a display, a speaker, and a microphone.

The modular door lock of any of the proceeding clauses, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

The modular door lock of any of the proceeding clauses, wherein the interior lock portion comprises a user interface.

The modular door lock of any of the proceeding clauses, wherein the user interface comprises at least one of a keypad having physical keys, a touchscreen, a touchscreen device enabling an electronic keypad, a sensor, a camera, a display, a speaker, and a microphone.

A method of implementing a modular door lock adapted to be attached to a door, the method comprising providing a bolt adapted to be received by a door frame; enabling controlling a movement of the bolt using a first latch element of an interior lock portion; and enabling controlling a movement of the bolt using a key actuator of an exterior lock portion; wherein one of the interior lock portion or the exterior lock portion comprises a module that is removably coupled to the modular door lock.

The method of any of the proceeding clauses, wherein the interior lock portion comprises a user interface comprising at least one of a keypad having physical keys, a touchscreen, a touchscreen device enabling an electronic keypad, a sensor, a camera, a display, a speaker, and a microphone.

The method of any of the proceeding clauses, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

The method of any of the proceeding clauses, wherein the exterior lock portion comprises a user interface.

The method of any of the proceeding clauses, wherein the user interface comprises at least one of a keypad having physical keys, a touchscreen, a touchscreen device enabling an electronic keypad, a sensor, a camera, a display, a speaker, and a microphone.

The method of any of the proceeding clauses, further comprising receiving a cover that is removably attached to cover the module.

The method of any of the proceeding clauses, wherein the module comprise one or more detachable modules.

A control module for an in-wall power adapter, the control module comprising a plurality of contact elements adapted to be coupled to contact elements of an in-wall power adapter; a wireless communication circuit adapted to communicate with a garage door opener; and a user interface adapted to transmit signals to a garage door opener or receive signals from the garage door opener.

The control module of any of the proceeding clauses, wherein the user interface comprises a status indicator indicating an opened or closed status of the garage door.

The control module of any of the proceeding clauses, wherein the status indicator comprises at least one of a display and a light emitting diode.

The control module of any of the proceeding clauses, wherein the user interface comprises a control interface for transmitting control signals.

The control module of any of the proceeding clauses, wherein the control signals comprise an open signal to open a garage door or a close signal to close a garage door.

The control module of any of the proceeding clauses, wherein the user interface is adapted to control multiple garage doors.

The control module of any of the proceeding clauses, wherein the user interface comprises a status indicator and a control actuator.

A control module for an in-wall power adapter, the control module comprising a plurality of contact elements adapted to be coupled to contact elements of an in-wall power adapter; a wireless communication circuit adapted to communicate with a garage door opener; an indicator element adapted to receive a signal from the garage door opener; and an actuator adapted to transmit signals to a garage door opener.

The control module of any of the proceeding clauses, wherein the indicator element comprises a status indicator indicating an opened or closed status of the garage door.

The control module of any of the proceeding clauses, wherein the indicator element comprises at least one of a display and a light emitting diode.

The control module of any of the proceeding clauses, wherein the actuator comprises a control interface for transmitting control signals.

The control module of any of the proceeding clauses, wherein the control signals comprise an open signal to open a garage door or a close signal to close a garage door.

The control module of any of the proceeding clauses, wherein the indicator element comprises a display indicating an opened or closed state of a garage door.

A method of implementing a control module, the method comprising providing a plurality of contact elements of a control module adapted to be coupled to contact elements of an in-wall power adapter; communicating, by way of a wireless communication circuit, with a garage door opener; transmitting, by way of a user interface, signals to a garage door opener; and receiving signals from the garage door opener.

The method of any of the proceeding clauses, further comprising providing a user interface on the control module, wherein the user interface comprises a status indicator indicating an open or closed status of the garage door.

The method of any of the proceeding clauses, wherein the status indicator comprises at least one of a display and a light emitting diode.

The method of any of the proceeding clauses, wherein the user interface comprises a control interface for transmitting control signals.

The method of any of the proceeding clauses, wherein the control signals comprise an open signal to open a garage door or a close signal to close a garage door.

The method of any of the proceeding clauses, wherein the user interface is adapted to control multiple garage doors.

The method of any of the proceeding clauses, wherein the user interface comprises a status indicator and a control actuator.

A system having a plurality of devices adapted to receive control modules, the system comprising a plurality of devices adapted to receive control modules, wherein each of the devices comprises a first plurality of contact elements that are adapted to receive a line voltage and a second plurality of contact elements adapted to provide the line voltage to a control module; and a plurality of control modules, wherein each control module is adapted to receive the line voltage; wherein a control module of the plurality of control modules is adapted to control an operation of a device of the plurality of devices.

The system of any of the proceeding clauses, wherein the plurality of devices comprises one or more of an in-wall power adapter, an indoor light fixture, an outdoor light fixture, a garage door opener, and a smoke detector.

The system of any of the proceeding clauses, wherein the plurality of control modules comprises one or more of control modules for controlling the on/off state of a device, a dimming level for a light, and a state of a garage door.

The system of any of the proceeding clauses, wherein the sensors comprises one or more of a temperature sensor, a humidity sensor, a motion sensor, a vibration sensor, a glass break sensor, an air quality sensor, an ambient light sensor, or any other sensor adapted to detect a physical or an environmental condition.

The system of any of the proceeding clauses, wherein one or more of the plurality of the control modules comprises a wireless communication device or circuit adapted to communicate with another device of the system.

The system of any of the proceeding clauses, wherein the wireless communication device or circuit is adapted to implement one or more protocols according to WiFi, Z-wave, Zigbee, Matter, Thread, Bluetooth, NFC protocols, or any type of proprietary wireless communication protocol.

The system of any of the proceeding clauses, wherein the plurality of control modules is further adapted to receive a DC voltage.

A method for implementing a system having a plurality of devices adapted to receive control modules, the method comprising a plurality of devices adapted to receive control modules, wherein each of the devices comprises a first plurality of contact elements that are adapted to receive a line voltage and a second plurality of contact elements adapted to provide the line voltage to a control module; and a plurality of control modules, wherein each control module is adapted to receive the line voltage; wherein a control module of the plurality of control modules is adapted to control an operation of a device of the plurality of devices.

The method of any of the proceeding clauses, wherein the plurality of devices comprises one or more of an in-wall power adapter, an indoor light fixture, an outdoor light fixture, a garage door opener, and a smoke detector.

The method of any of the proceeding clauses, wherein the plurality of control modules comprises one or more of control modules for controlling the on/off state of a device, a dimming level for a light, and a state of a garage door.

The method of any of the proceeding clauses, wherein the sensors comprises one or more of a temperature sensor, a humidity sensor, a motion sensor, a vibration sensor, a glass break sensor, an air quality sensor, an ambient light sensor, or any other sensor adapted to detect a physical or an environmental condition.

The method of any of the proceeding clauses, wherein one or more of the plurality of the control modules comprises a wireless communication device or circuit adapted to communicate with another device of the system.

The method of any of the proceeding clauses, wherein the wireless communication device or circuit is adapted to implement one or more protocols according to WiFi, Z-wave, Zigbee, Matter, Thread, Bluetooth, NFC protocols, or any type of proprietary wireless communication protocol.

The method of any of the proceeding clauses, wherein the plurality of control modules is further adapted to receive a DC voltage.

1. A modular door lock adapted to be attached to a door, the modular door lock comprising:
a bolt adapted to be received by a door frame;
an interior lock portion comprising a first latch element adapted to control a movement of the bolt; and
an exterior lock portion comprising a key actuator adapted to control a movement of the bolt;
wherein the interior lock portion comprises a module that is removably coupled to the interior lock portion.

2. The modular door lock of claim 1, wherein the interior lock portion comprises a user interface.

3. The modular door lock of claim 2, wherein the user interface comprises at least one of a keypad having physical keys, a touchscreen, a touchscreen device enabling an electronic keypad, a sensor, a camera, a display, a speaker, and a microphone.

4. The modular door lock of claim 3, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

5. The modular door lock of claim 1, wherein the exterior lock portion comprises a user interface comprising at least one or a keypad having physical keys, a touchscreen, a touchscreen device enabling an electronic keypad, a sensor, a camera, a display, a speaker, and a microphone.

6. The modular door lock of claim 1, further comprising a cover that is removably attached to the interior lock portion to cover the module.

7. The modular door lock of claim 1, wherein the module comprise one or more detachable modules.

8. A modular door lock adapted to be attached to a door, the modular door lock comprising:
a bolt adapted to be received by a door frame;
an interior lock portion comprising a first latch element adapted to control a movement of the bolt; and
an exterior lock portion comprising a key actuator adapted to control a movement of the bolt;
wherein the exterior lock portion comprises a module that is removably coupled to the exterior lock portion.

9. The modular door lock of claim 8, wherein the exterior lock portion comprises a user interface.

10. The modular door lock of claim 9, wherein the user interface comprises at least one of a keypad having physical keys, a touchscreen, a touchscreen device enabling an electronic keypad, a sensor, a camera, a display, a speaker, and a microphone.

11. The modular door lock of claim 10, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

12. The modular door lock of claim 8, wherein the interior lock portion comprises a user interface.

13. The modular door lock of claim 11, wherein the user interface comprises at least one of a keypad having physical keys, a touchscreen, a touchscreen device enabling an electronic keypad, a sensor, a camera, a display, a speaker, and a microphone.

14. A method of implementing a modular door lock adapted to be attached to a door, the method comprising:
providing a bolt adapted to be received by a door frame;
enabling controlling a movement of the bolt using a first latch element of an interior lock portion; and
enabling controlling a movement of the bolt using a key actuator of an exterior lock portion;
wherein one of the interior lock portion or the exterior lock portion comprises a module that is removably coupled to the modular door lock.

15. The method of claim 14, wherein the interior lock portion comprises a user interface comprising at least one of a keypad having physical keys, a touchscreen, a touchscreen device enabling an electronic keypad, a sensor, a camera, a display, a speaker, and a microphone.

16. The method of claim 15, wherein the sensor comprises one or more of a temperature sensor, a humidity sensor, a motion sensor, a vibration sensor, a glass break sensor, an air quality sensor, an ambient light sensor, or any other sensor adapted to detect a physical or an environmental condition.

17. The method of claim 14, wherein the exterior lock portion comprises a user interface.

18. The method of claim 17, wherein the user interface comprises at least one of a keypad having physical keys, a touchscreen, a touchscreen device enabling an electronic keypad, a sensor, a camera, a display, a speaker, and a microphone.

19. The method of claim 14, further comprising receiving a cover that is removably attached to cover the module.

20. The method of claim 14, wherein the module comprise one or more detachable modules.
